(19) United States
(12) Patent Application Publication
(10) Pub. No.: US 2025/0282649 A1
(43) Pub. Date: Sep. 11, 2025

(54) BALANCER AND METHODS FOR EXTRACTING WATER FROM AN AQUEOUS SOLUTION

(71) Applicant: IONIC WATER TECHNOLOGIES, LLC, Hamilton, NJ (US)

(72) Inventors: George W ADAMSON, Hamilton, NJ (US); Annie MCCULLOUGH, Hamilton, NJ (US); Robert Chris HOLLEY, Hamilton, NJ (US)

(21) Appl. No.: 18/862,493

(22) PCT Filed: May 12, 2023
(86) PCT No.: PCT/US23/21971

§ 371 Date: Nov. 1, 2024

Related U.S. Application Data
(60) Provisional application No. 63/341,789, filed on May 13, 2022.

(51) Int. Cl. C02F 1/26; C02F 1/02; C02F 103/08

(52) U.S. Cl. CPC C02F 1/265; C02F 1/02; C02F 2103/08; C02F 2201/005; C02F 2201/009; C02F 2209/02; C02F 2209/29; C02F 2209/44

(57) ABSTRACT

The present invention provides methods and systems for extracting water from aqueous solutions (e.g., aqueous NaCl solutions) using an extraction agent.

### CROSS REFERENCE TO RELATED APPLICATION

This application claims priority to U.S. provisional application No. 63/341,789, filed on May 13, 2022, which is incorporated by reference in its entirety.

### FIELD OF THE INVENTION

The present invention relates to a balancer and methods for extracting water from an aqueous solution.

### BACKGROUND

Potable water and water suitable for agricultural use are essential for human life. Presently, 2.3 billion people throughout the world live in water-stressed countries. Of these 2.3 billion people, about thirty-two percent (32%) live in regions that are considered highly and/or critically water-stressed.

Aqueous solutions having high levels of salinity (e.g., seawater, brackish water, and well water) represent a potential resource for addressing water scarcity issues across the globe. However, conventional systems and methods for extracting water (e.g., potable water or water suitable for agricultural use) from aqueous solutions suffer from several drawbacks. Specifically, conventional systems and methods for extracting water from aqueous solutions are inefficient and/or too costly to be practicable. Many conventional systems and methods rely on large amounts of electricity to produce potable water. Some conventional systems and methods require the transportation of aqueous solutions over long distances, thereby increasing the inefficiencies and costs associated with producing potable water. Other conventional systems produce large amounts of brine that must be disposed of or otherwise utilized, thereby increasing costs associated with water extraction. And, some conventional systems require components (e.g., filter systems) that are expensive to maintain.

As such, there remains a need to provide improved systems and methods for extracting water from aqueous solutions.

### SUMMARY OF THE INVENTION

In one aspect, the present invention provides a method for extracting water from an aqueous solution comprising:
(a-1) mixing (or contacting) an extraction agent and the aqueous solution at about ambient temperature to form a first feed mixture including a wet extraction agent phase and a raffinate phase, wherein the aqueous solution comprises a concentration of sodium chloride;
(b-1) removing at least a portion of the raffinate phase from the first feed mixture;
(c-1) heating the wet extraction agent phase to a temperature of from about 35° C. to about 130° C. to form a second feed mixture including a heated extraction agent phase and a heated aqueous solution phase;
(d-1) reducing the volume of the second feed mixture to provide a balanced mixture having a volume ratio of from about 5:1 to about 1:10 of heated extraction agent phase to heated aqueous solution phase;
(e-1) reducing the temperature of the balanced mixture by at least 15° C. (e.g., from about 15° C. to about 35° C.) to form a cooled mixture including a cooled extraction agent phase and a cooled aqueous solution phase;
(f-1) removing at least a portion of the cooled aqueous solution phase from the cooled mixture to form a concentrated extraction agent mixture; and
(g-1) heating the concentrated extraction agent mixture to a temperature of from about 35° C. to about 130° C. to form a dry extraction agent phase and a water phase, wherein the water phase comprises a concentration of sodium chloride that is less than the concentration of sodium chloride in the aqueous solution.

In some implementations, the aqueous solution has a concentration of sodium chloride of greater than about 8,500 mg/L (e.g., from about 10,000 mg/L to about 50,000 mg/L, from about 15,000 mg/L to about 45,000 mg/L, from about 20,000 mg/L to about 40,000 mg/L, or from about 27,000 mg/L to about 37,000 mg/L). In some implementations, the aqueous solution comprises a concentration of sodium chloride from about 350 mg/L to about 40,000 mg/L. For example, an aqueous solution sourced from a well may comprise a concentration of sodium chloride from about 1,000 mg/L to about 10,000 mg/L.

In some implementations, step (a-1) comprises mixing (or contacting) a volume ratio of from about 5:1 to about 1:5 of extraction agent to aqueous solution. In some implementations, step (a-1) comprises mixing (or contacting) the extraction agent and the aqueous solution for a period of from about 1 second to about 5 minutes (e.g., from about 3 seconds to about 5 minutes). In some implementations, step (a-1) comprises mixing (or contacting) the extraction agent and the aqueous solution for a period of from about 30 seconds to about 2 minutes.

In some implementations, the extraction agent has a density that is less than the density of the aqueous solution. In some implementations, the extraction agent comprises a tertiary or secondary amine or salt thereof (e.g., a HCl salt thereof) having the formula N(R¹)₃, wherein each R¹ is independently hydrogen, an optionally substituted straight or branched C₁₋₂₀ alkyl (e.g., C₁₋₁₀ alkyl), an optionally substituted C₃₋₁₄ mono- or bicyclic cycloalkyl (e.g., C₃₋₁₀ mono- or bicyclic cycloalkyl), or an optionally substituted C₆₋₁₄ mono- or bicyclic aryl, wherein the alkyl, cycloalkyl, and aryl of R¹ are each optionally and independently substituted with up to two halogen or C₁₋₆ alkyl (e.g., C₁₋₃ alkyl) groups.

In other implementations, the extraction agent comprises a di-amine or salt thereof (e.g., a HCl salt thereof) having the formula (R¹)₂N-L-N(R¹)₂ wherein L is a C₁₋₁₄ bivalent, straight or branched alkylene chain, and each R¹ is independently hydrogen, an optionally substituted straight or branched C₁₋₂₀ alkyl, an optionally substituted C₃₋₁₄ mono- or bicyclic cycloalkyl, or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

In some implementations, the extraction agent comprises methylamine; ethylamine; propylamine; isopropylamine; butylamine; sec-butylamine; iso-butylamine; tert-butylamine; amylamine; hexylamine; heptylamine; 1-methylhexylamine; octylamine; 1-ethylpentylamine; 2-ethylhexylamine; 2-ethylbutylamine; 2-ethyl-1-hexylamine; tert-octylamine; nonylamine; decylamine; dodecylamine; hexadecylamine; octadecylamine; dimethylamine; diethylamine; dipropylamine; di-iso-propylamine; dibutylamine; di-sec-butylamine; di-iso-butylamine; di-tert-butylamine; diisobutylamine; N,N-ethylcyclohexylamine; N-methylcyclohexylamine; N-methyl-tert-butylamine; N-methyl-iso-butylamine; N-methylpentylamine; di-allylamine; N-ethylmethylamine; N-iso-propylmethylamine; N-methylbutylamine; N-methyl-n-amylamine; N-ethyl-tert-butylamine; N-ethyl-sec-butylamine; N-ethylpropylamine; N-ethyl-iso-propylamine; N-ethyl-n-butylamine; dioctylamine; N-methyldodecylamine; propylbutylamine; N-ethylbenzylamine; 1,3-dimethylbutylamine; N,N-dimethyl-iso-propylamine; dimethylpropylamine; N,N-dimethyl-iso-butylamine; N,N-dimethyl-tert-butylamine; N,N-dimethylcyclohexylamine; N,N-dimethylethylamine; N,N-diethylmethylamine; triethylamine; di-iso-propylmethylamine; 2-(isopropylamino) ethanol; tripropylamine; trioctylamine; N,N-dimethylhexadecylamine; 1,8-diaminooctane; 1,12-diaminododecane; 1,3-dimethylamylamine; 2-aminopentane; N,N,5,5-tetramethyl-1,3-dioxan-2amine; bis[3-trimethoxysilyl)propyl]amine; octanoic acid; decanoic acid; hexanoic acid; tri-8-chlorooctylamine; trioctylamine; trioctadecylamine; or any combination thereof. And, in some embodiments, the extraction agent comprises dipropylamine; di-iso-propylamine; or any combination thereof.

In some implementations, step (b-1) comprises removing from about 50% to about 100% by volume of the raffinate phase from the first feed mixture. In other implementations, step (b-1) comprises removing from about 80% to about 100% by volume of the raffinate phase from the first feed mixture.

In some implementations, step (c-1) comprises heating the wet extraction agent phase to a temperature of from about 45° C. to about 90° C. In other implementations, step (c-1) comprises heating the wet extraction agent phase to a temperature of from about 50° C. to about 130° C. (e.g., from about 50° C. to about 85° C.).

In some implementations, step (d-1) comprises removing a portion of the heated extraction agent phase from the second mixture to provide a balanced mixture having a volume ratio of from about 5:1 to about 1:10 of heated extraction agent phase to heated aqueous solution phase. In some implementations, step (d-1) comprises removing the portion of the heated extraction agent phase from the second feed mixture to provide a balanced mixture having a volume ratio of from about 3:1 to about 1:3 of heated extraction agent phase to heated aqueous solution phase. In other implementations, step (d-1) comprises removing a portion of the heated aqueous solution phase from the second mixture to provide a balanced mixture having a volume ratio of from about 5:1 to about 1:10 of heated extraction agent phase to heated aqueous solution phase. And, in some implementations, step (d-1) comprises detecting the volume of the heated extraction agent phase or the volume of heated aqueous solution phase.

In some implementations, step (e-1) comprises reducing the temperature of the balanced mixture to a temperature of from about 15° C. to about 35° C. to form the cooled mixture. In some implementations, step (e-1) comprises reducing the temperature of the balanced mixture to about ambient temperature to form the cooled mixture.

In some implementations, step (f-1) comprises removing from about 50% to about 100% of the cooled aqueous solution phase from the cooled mixture. In other implementations, step (f-1) comprises removing from about 75% to about 90% of the cooled aqueous solution phase from the cooled mixture.

In some implementations, step (g-1) comprises heating the concentrated extraction agent mixture to a temperature of from about 45° C. to about 90° C. In other implementations, step (g-1) comprises heating the concentrated extraction agent mixture to a temperature of from about 50° C. to about 85° C.

In some implementations, the concentration of sodium chloride in the water phase is from about 70% to about 99% less than the concentration of sodium chloride in the aqueous solution. For example, the concentration of sodium chloride in the water phase is from about 70% to about 90% less than the concentration of sodium chloride in the aqueous solution.

In some implementations, the method further comprises:
(h-1) treating at least a portion of the water phase to remove extraction agent.
   For example, step (h-1) comprises sparging, distilling, or osmotically filtering the water phase to remove extraction agent from the water phase.

Another aspect of the present invention provides a balancer for extracting water from an aqueous solution. The balancer comprises a first feed stream, a first heater, a second feed stream, and an extractor. The first feed stream comprises a first stream channel and a first stream outlet. The first stream channel is configured to mix an extraction agent and an aqueous solution under ambient temperature to form a wet extraction phase and a raffinate phase. The density of the wet extraction phase is less than or greater than the density of the raffinate phase depending on the composition of the extraction agent. In some examples, the density of the wet extraction phase is less than the density of the raffinate phase. The aqueous solution has a concentration of sodium chloride. The first stream outlet is configured to permit at least a portion of the raffinate phase to exit the first stream channel and form a reduced first feed stream. The first heater fluidly communicates with the first stream channel and thermally communicates with the reduced first feed stream. The first heater is configured to heat at least a portion of the reduced first feed stream to a temperature of from about 35° C. to about 130° C. to form a heated extraction agent phase and a heated aqueous solution phase. The first heater comprises a first heater outlet configured to permit a portion of the heated extraction agent phase to exit the first heater to give a heated balanced mixture including a volume ratio of heated extraction agent phase to heated aqueous solution phase of from about 5:1 to about 1:10. The second feed stream comprises a second stream channel and a second stream outlet. The second stream channel fluidly communicates with the first heater and is configured to cool the heated balanced mixture to form a volume-adjusted wet extraction agent phase and a cooled aqueous solution phase. The second stream outlet is configured to permit at least a portion of the cooled aqueous solution phase to exit the second stream channel and form a concentrated wet extraction agent mixture. The extractor fluidly communicates with the second stream channel and comprises an extractor heater and a water outlet. The extractor heater is configured to heat at least a portion of the concentrated wet extraction agent mixture to a temperature of from about 35° C. to about 130° C. to form a dry extraction agent phase and a water phase. The water outlet is configured permit at least a portion of the water phase to exit the extractor.

In some embodiments, the first stream channel is configured to mix the extraction agent and the aqueous solution for a period of from about 1 second to about 5 minutes (e.g., from about 3 seconds to about 5 minutes). For example, the first stream channel is configured to mix the extraction agent and the aqueous solution for a period of from about 30 seconds to about 2 minutes. In some embodiments, the first stream channel is configured to contact a stream of extraction agent with a stream of aqueous solution. In some embodiments, the first stream outlet is configured to permit the portion of the raffinate phase exiting the first stream channel to be released into the environment.

In some embodiments, the balancer further comprises a sparging tank fluidly communicating with the first stream outlet, wherein the sparging tank is configured to sparge at least a portion of the raffinate to remove extraction agent from the raffinate.

In some embodiments, first stream outlet comprises a valve fluidly coupled to the first stream channel. In some embodiments, the first stream outlet is configured to retain from about 75% to about 99% of the wet extraction agent phase in the first stream channel while permitting the portion of the raffinate phase to exit the first stream channel.

In some embodiments, the balancer further comprises a first stream actuator fluidly communicating with an upstream portion of the first feed stream wherein the first stream actuator provides the extraction agent, the aqueous solution, or both to the first stream channel.

In some embodiments, the first heater is configured to heat the portion of the reduced first feed stream to a temperature of from about 45° C. to about 90° C. In some embodiments, the first heater comprises one or more heating elements. And, in some embodiments, the balancer further comprises a solar cell configured to power the first heater, the first stream actuator, the extractor heater, or any combination thereof.

In some embodiments, the balancer further comprises a recycling conduit fluidly communicating with the first heater outlet and the first feed stream, wherein the recycling conduit is configured to permit a portion of the heated extraction agent phase to exit the first heater and return to the first feed stream as extraction agent. In some embodiments, the first heater outlet is configured to permit the portion of heated extraction agent phase to exit the first heater substantially free of heated raffinate phase. In some embodiments, the portion of heated extraction agent phase exiting the first heater comprises from 0% to about 25% by volume of the heated raffinate phase.

In some embodiments, the extractor comprises an extraction agent outlet, and the extraction agent outlet comprises a valve configured to permit from about 75% to about 100% by volume of the dry extraction agent to exit the extractor.

In some embodiments, the balancer further comprises a second recycling conduit fluidly communicating with the extraction agent outlet, wherein the second recycling conduit is configured to return the dry extraction agent exiting the extractor to the first feed stream as extraction agent.

In some embodiments, the extractor heater is configured to heat the portion of the concentrated wet extraction agent to a temperature of from about 45° C. to about 90° C.

In some embodiments, the water phase has a concentration of sodium chloride that is less than the concentration of sodium chloride in the aqueous solution. For example, the water phase has a concentration of sodium chloride that is from about 65% to about 90% less than the concentration of sodium chloride in the aqueous solution. In some embodiments, the aqueous solution comprises a concentration of sodium chloride of from about 300 mg/L to about 40,000 mg/L. In other embodiments, the aqueous solution has a concentration of sodium chloride of greater than about 8,500 mg/L (e.g., from about 10,000 mg/L to about 50,000 mg/L, from about 15,000 mg/L to about 45,000 mg/L, from about 20,000 mg/L to about 40,000 mg/L, or from about 27,000 mg/L to about 37,000 mg/L). And, in some embodiments, the aqueous solution comprises seawater or well water.

In some embodiments, the balancer further comprises a sparger in fluid communication with the water outlet, wherein the sparger is configured to vaporize extraction agent from the water phase.

In some embodiments, the first heater further comprises a rate meter that cooperates with the first heater outlet to modulate the flow of the heated extraction agent phase and heated raffinate phase to form the balanced mixture.

In some implementations, the extraction agent has a density that is less than the density of the aqueous solution. In some implementations, the extraction agent comprises a tertiary or secondary amine having the formula N(R¹)₃, wherein each R¹ is independently hydrogen, an optionally substituted straight or branched C₁₋₂₀ alkyl, an optionally substituted C₁₋₁₄ mono- or bicyclic cycloalkyl, or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

In other implementations, the extraction agent comprises a di-amine having the formula (R¹)₂N-L-N(R¹)₂ wherein L is a C₁₋₁₄ bivalent, straight or branched alkylene chain, and each R¹ is independently hydrogen, an optionally substituted straight or branched C₁₋₂₀ alkyl, an optionally substituted C₁₋₁₄ mono- or bicyclic cycloalkyl, or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

In some embodiments, the extraction agent comprises methylamine; ethylamine; propylamine; isopropylamine; butylamine; sec-butylamine; iso-butylamine; tert-butylamine; amylamine; hexylamine; heptylamine; 1-methylhexylamine; octylamine; 1-ethylpentylamine; 2-ethylhexylamine; 2-ethylbutylamine; 2-ethyl-1-hexylamine; tert-octylamine; nonylamine; decylamine; dodecylamine; hexadecylamine; octadecylamine; dimethylamine; diethylamine; dipropylamine; di-iso-propylamine; dibutylamine; di-sec-butylamine; di-iso-butylamine; di-tert-butylamine; diisobutylamine; N,N-ethylcyclohexylamine; N-methylcyclohexylamine; N-methyl-tert-butylamine; N-methyl-iso-butylamine; N-methylpentylamine; di-allylamine; N-ethylmethylamine; N-iso-propylmethylamine; N-methylbutylamine; N-methyl-n-amylamine; N-ethyl-tert-butylamine; N-ethyl-sec-butylamine; N-ethylpropylamine; N-ethyl-iso-propylamine; N-ethyl-n-butylamine; dioctylamine; N-methyldodecylamine; propylbutylamine; N-ethylbenzylamine; 1,3-dimethylbutylamine; N,N-dimethyl-iso-propylamine; dimethylpropylamine; N,N-dimethyl-iso-butylamine; N,N-dimethyl-tert-butylamine; N,N-dimethylcyclohexylamine; N,N-dimethylethylamine; N,N-diethylmethylamine; triethylamine; di-iso-propylmethylamine; 2-(isopropylamino) ethanol; tripropylamine; trioctylamine; N,N-dimethylhexadecylamine; 1,8-diaminooctane; 1,12-diaminododecane; 1,3-dimethylamylamine; 2-aminopentane; N,N,5,5-tetramethyl-1,3-dioxan-2amine; bis[3-trimethoxysilyl)propyl]amine; octanoic acid; decanoic acid; hexanoic acid; tri-8-chlorooctylamine; trioctylamine; trioctadecylamine; or any combination thereof. And, in some embodiments, the extraction agent comprises dipropylamine; di-iso-propylamine; or any combination thereof.

In another aspect, the present invention provides a method of extracting water from an aqueous solution. The method comprises:
(a-6) mixing an extraction agent and the aqueous solution at about ambient temperature to form a first feed mixture including a wet extraction agent phase and a raffinate phase, wherein the aqueous solution comprises a concentration of sodium chloride;
(b-6) removing from about 50% to about 100% by volume of the raffinate phase from the first feed mixture to form a concentrated wet extraction agent phase;
(c-6) heating the wet extraction agent phase to a temperature of from about 35° C. to about 130° C. to form a heated mixture including a dry extraction agent phase and a water phase, wherein the water phase comprises a concentration of sodium chloride that is less than the concentration of sodium chloride in the aqueous solution; and
(d-6) recycling at least a portion of the dry extraction agent phase for use as extraction agent in mixing step (a-6).

In some implementations, step (a-6) comprises mixing the extraction agent and the aqueous solution at a volume ratio of from about 5:1 to about 1:5. In some implementations, the aqueous solution comprises a concentration of sodium chloride of from about 300 mg/L to about 45,000 mg/L. In some implementations, the aqueous solution has a concentration of sodium chloride of greater than about 8,500 mg/L (e.g., from about 10,000 mg/L to about 50,000 mg/L, from about 15,000 mg/L to about 45,000 mg/L, from about 20,000 mg/L to about 40,000 mg/L, or from about 27,000 mg/L to about 37,000 mg/L). In some implementations, step (a-6) comprises contacting at least one stream of aqueous solution with at least one stream of extraction agent. In some implementations, step (a-6) comprises mixing the extraction agent and the aqueous solution with a rotor or shaker. And, in some implementations, step (a-6) comprises mixing the extraction agent and the aqueous solution for a period of from about 3 seconds to about 5 minutes.

In some implementations, the extraction agent has a density that is less than the density of the aqueous solution. In some implementations, the extraction agent comprises a tertiary or secondary amine having the formula N(R¹)₃, wherein each R¹ is independently hydrogen, an optionally substituted straight or branched C₁₋₂₀ alkyl, an optionally substituted C₁₋₁₄ mono- or bicyclic cycloalkyl, or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

In other implementations, the extraction agent comprises a di-amine having the formula (R¹)₂N-L-N(R¹)₂ wherein L is a C₁₋₁₄ bivalent, straight or branched alkylene chain, and each R¹ is independently hydrogen, an optionally substituted straight or branched C₁₋₂₀ alkyl, an optionally substituted C₁₋₁₄ mono- or bicyclic cycloalkyl, or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

In some embodiments, the extraction agent comprises methylamine; ethylamine; propylamine; isopropylamine; butylamine; sec-butylamine; iso-butylamine; tert-butylamine; amylamine; hexylamine; heptylamine; 1-methylhexylamine; octylamine; 1-ethylpentylamine; 2-ethylhexylamine; 2-ethylbutylamine; 2-ethyl-1-hexylamine; tert-octylamine; nonylamine; decylamine; dodecylamine; hexadecylamine; octadecylamine; dimethylamine; diethylamine; dipropylamine; di-iso-propylamine; dibutylamine; di-sec-butylamine; di-iso-butylamine; di-tert-butylamine; diisobutylamine; N,N-ethylcyclohexylamine; N-methylcyclohexylamine; N-methyl-tert-butylamine; N-methyl-iso-butylamine; N-methylpentylamine; di-allylamine; N-ethylmethylamine; N-iso-propylmethylamine; N-methylbutylamine; N-methyl-n-amylamine; N-ethyl-tert-butylamine; N-ethyl-sec-butylamine; N-ethylpropylamine; N-ethyl-iso-propylamine; N-ethyl-n-butylamine; dioctylamine; N-methyldodecylamine; propylbutylamine; N-ethylbenzylamine; 1,3-dimethylbutylamine; N,N-dimethyl-iso-propylamine; dimethylpropylamine; N,N-dimethyl-iso-butylamine; N,N-dimethyl-tert-butylamine; N,N-dimethylcyclohexylamine; N,N-dimethylethylamine; N,N-diethylmethylamine; triethylamine; di-iso-propylmethylamine; 2-(isopropylamino) ethanol; tripropylamine; trioctylamine; N,N-dimethylhexadecylamine; 1,8-diaminooctane; 1,12-diaminododecane; 1,3-dimethylamylamine; 2-aminopentane; N,N,5,5-tetramethyl-1,3-dioxan-2amine; bis[3-trimethoxysilyl)propyl]amine; octanoic acid; decanoic acid; hexanoic acid; tri-8-chlorooctylamine; trioctylamine; trioctadecylamine; or any combination thereof. And, in some embodiments, the extraction agent comprises dipropylamine; di-iso-propylamine; or any combination thereof.

In some implementations, step (b-6) comprises removing from about 80% to about 100% by volume of the raffinate phase. In some implementations, step (b-6) comprises:
(b-6a) treating at least a portion of the raffinate phase to remove extraction agent and releasing the treated raffinate into the environment.
   For example, step (b-6a) comprises treating the portion of the raffinate phase by sparging or filtering with an osmotic filter. And, in some implementations, the removal of the raffinate phase in step (b-6) is performed by a pump or gravity fed outlet.

In some implementations, step (c-6) comprises heating the wet extraction agent phase to a temperature of from about 45° C. to about 90° C. For example, step (c-6) comprises maintaining the temperature of the heated wet extraction agent phase at a temperature of from about 45° C. to about 90° C. for a period of from about 30 s to about 5 min. In some implementations, the heating of step (c-6) is performed by one or more solar-powered heating elements. And, in some implementations, the water phase of step (c-6) comprises a concentration of sodium chloride that is from about 70% to about 99% less than the concentration of sodium chloride in the aqueous solution.

In some implementations, step (c-6) comprises:
(c-6a) treating at least a portion of the water phase to remove extraction agent.
   For example, step (c-6a) comprises treating the portion of the water phase by sparging or filtering with an osmotic filter.

In another aspect, the present invention provides a method for extracting water from an aqueous solution. The method comprises:
(a-7) mixing a first extraction agent and the aqueous solution at about ambient temperature to form a first feed mixture including a wet extraction agent phase and a raffinate phase, wherein the aqueous solution comprises a concentration of sodium chloride;
(b-7) removing at least a portion of the raffinate phase from the first feed mixture;
(c-7) heating the wet extraction agent phase to a temperature of from about 35° C. to about 130° C. to form a second feed mixture including a heated extraction agent phase and a heated aqueous solution phase;
(d-7) removing at least a portion of the heated extraction agent phase from the second feed mixture to provide a diluted aqueous solution phase;
(e-7) mixing the diluted aqueous solution phase with a second extraction agent to form a second wet extraction agent phase and a second raffinate phase;
(f-7) removing at least a portion of the second raffinate phase to form a concentrated wet extraction agent phase;
(g-7) heating the concentrated wet extraction agent phase to a temperature of from about 35° C. to about 130° C. to form a dry extraction agent phase and a water phase; and
(h-7) recovering the water phase,
   wherein the water phase has a concentration of sodium chloride that is less than the concentration of sodium chloride in the aqueous solution.

In some implementations, step (a-7) comprises mixing the first extraction agent and the aqueous solution at a volume ratio of from about 5:1 to about 1:5 of first extraction agent to aqueous solution. In other implementations, step (a-7) comprises mixing the first extraction agent and the aqueous solution for a period of from about 3 seconds to about 5 minutes. For example, step (a-7) comprises mixing the first extraction agent and the aqueous solution for a period of from about 30 seconds to about 2 minutes.

In some implementations, the first extraction agent has a density that is less than the density of the aqueous solution. In some implementations, the first extraction agent comprises a tertiary or secondary amine having the formula N(R¹)₃, wherein each R¹ is independently hydrogen, an optionally substituted straight or branched C₁₋₂₀ alkyl, an optionally substituted C₁₋₁₄ mono- or bicyclic cycloalkyl, or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

In other implementations, the first extraction agent comprises a di-amine having the formula (R¹)₂N-L-N(R¹)₂ wherein L is a C₁₋₁₄ bivalent, straight or branched alkylene chain, and each R¹ is independently hydrogen, an optionally substituted straight or branched C₁₋₂₀ alkyl, an optionally substituted C₁₋₁₄ mono- or bicyclic cycloalkyl, or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

In some embodiments, the first extraction agent comprises methylamine; ethylamine; propylamine; isopropylamine; butylamine; sec-butylamine; iso-butylamine; tert-butylamine; amylamine; hexylamine; heptylamine; 1-methylhexylamine; octylamine; 1-ethylpentylamine; 2-ethylhexylamine; 2-ethylbutylamine; 2-ethyl-1-hexylamine; tert-octylamine; nonylamine; decylamine; dodecylamine; hexadecylamine; octadecylamine; dimethylamine; diethylamine; dipropylamine; di-isopropylamine; dibutylamine; di-sec-butylamine; di-iso-butylamine; di-tert-butylamine; diisobutylamine; N,N-ethylcyclohexylamine; N-methylcyclohexylamine; N-methyl-tert-butylamine; N-methyl-iso-butylamine; N-methylpentylamine; di-allylamine; N-ethylmethylamine; N-iso-propylmethylamine; N-methylbutylamine; N-methyl-n-amylamine; N-ethyl-tert-butylamine; N-ethyl-sec-butylamine; N-ethylpropylamine; N-ethyl-iso-propylamine; N-ethyl-n-butylamine; dioctylamine; N-methyldodecylamine; propylbutylamine; N-ethylbenzylamine; 1,3-dimethylbutylamine; N,N-dimethyl-iso-propylamine; dimethylpropylamine; N,N-dimethyl-iso-butylamine; N,N-dimethyl-tert-butylamine; N,N-dimethylcyclohexylamine; N,N-dimethylethylamine; N,N-diethylmethylamine; triethylamine; di-iso-propylmethylamine; 2-(isopropylamino) ethanol; tripropylamine; trioctylamine; N,N-dimethylhexadecylamine; 1,8-diaminooctane; 1,12-diaminododecane; 1,3-dimethylamylamine; 2-aminopentane; N,N,5,5-tetramethyl-1,3-dioxan-2amine; bis[3-trimethoxysilyl)propyl]amine; octanoic acid; decanoic acid; hexanoic acid; tri-8-chlorooctylamine; trioctylamine; trioctadecylamine; or any combination thereof. And, in some embodiments, the first extraction agent comprises dipropylamine; di-iso-propylamine; or any combination thereof.

In some implementations, the aqueous solution comprises a concentration of sodium chloride of from about 350 mg/L to about 40,000 mg/L. In some implementations, the aqueous solution has a concentration of sodium chloride of greater than about 8,500 mg/L (e.g., from about 10,000 mg/L to about 50,000 mg/L, from about 15,000 mg/L to about 45,000 mg/L, from about 20,000 mg/L to about 40,000 mg/L, or from about 27,000 mg/L to about 37,000 mg/L).

In some implementations, step (b-7) comprises removing from about 50% to about 100% by volume of the raffinate phase from the first feed mixture. For example, step (b-7) comprises removing from about 80% to about 100% by volume of the raffinate phase from the first mixture.

In some implementations, step (c-7) comprises heating the wet extraction agent phase to a temperature of from about 45° C. to about 90° C. For example, step (c-7) comprises heating the wet extraction agent phase to a temperature of from about 50° C. to about 85° C.

In some implementations, step (d-7) comprises:
(d-2a) recycling at least a portion of the heated extraction agent removed from the second feed mixture for use as extraction agent in mixing step (a-7).

In some implementations, step (e-7) comprises reducing the temperature of the diluted aqueous solution phase by from about 10° C. to about 60° C. prior to mixing with the second extraction agent. In some implementations, step (e-7) comprises reducing the temperature of the diluted aqueous solution phase to about ambient temperature prior to mixing with the second extraction agent.

In some implementations, step (f-7) comprises removing from about 50% to about 100% of the second raffinate phase. For example, step (f-7) comprises removing from about 75% to about 90% of the second raffinate phase.

In some implementations, step (g-7) comprises heating the concentrated wet extraction agent phase to a temperature of from about 45° C. to about 90° C. For example, step (g-7) comprises heating the concentrated wet extraction agent phase to a temperature of from about 50° C. to about 85° C.

In some implementations, the concentration of sodium chloride in the water phase is from about 70% to about 90% less than the concentration of sodium chloride in the aqueous solution.

In some implementations, the method further comprises:
(i-7) recycling at least a portion of the dry extraction agent phase for use as extraction agent in mixing step (a-7).

In some implementations, the method further comprises:
(j-7) treating at least a portion of the water phase to remove extraction agent.

For example, step (j-7) comprises sparging or osmotically filtering the water phase to remove extraction agent from the water phase.

Other features and advantages of the invention will be apparent from the following detailed description, figures, and from the claims.

### BRIEF DESCRIPTION OF THE DRAWINGS

The following figures are provided by way of example and are not intended to limit the scope of the claimed invention.

FIG. 1 is a schematic of a balancer for extracting water from an aqueous solution according to an embodiment of the invention.

FIG. 2 is a schematic of a system for extracting water from an aqueous solution according to an embodiment of the invention.

FIG. 3 is a flow chart of a method for extracting water from an aqueous solution according to one embodiment of the invention.

FIG. 4 is a flow chart of a method for extracting water from an aqueous solution according to another embodiment of the invention.

FIG. 5 is a flow chart of a method for extracting water from an aqueous solution according to yet another embodiment of the invention.

### DETAILED DESCRIPTION

### I. Definitions

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The terms, upper, lower, above, beneath, right, left, etc. may be used herein to describe the position of various elements with relation to other elements. These terms represent the position of elements in an example configuration. However, it will be apparent to one skilled in the art that the elements may be rotated in space without departing from the present disclosure and thus, these terms should not be used to limit the scope of the present disclosure.

As used herein, when an element is referred to as being “on,” “engaged to,” “connected to,” “attached to,” or “coupled to” another element, it may be directly on, engaged, connected, attached, or coupled to the other element, or intervening elements may be present. In contrast, when an element is referred to as being “directly on,” “directly engaged to,” “directly connected to,” “directly attached to,” or “directly coupled to” another element, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As used herein, the term “extraction agent” refers to a material that is substantially immiscible with aqueous solutions, capable of water absorption at a first temperature (e.g., about ambient temperature), and exhibits decreased water solubility at a second temperature (e.g., about 35° C. to about 130° C.) that is higher than the first temperature. Non-limiting examples of the extraction agents include methylamine; ethylamine; propylamine; isopropylamine; butylamine; sec-butylamine; iso-butylamine; tert-butylamine; amylamine; hexylamine; heptylamine; 1-methylhexylamine; octylamine; 1-ethylpentylamine; 2-ethylhexylamine; 2-ethylbutylamine; 2-ethyl-1-hexylamine; tert-octylamine; nonylamine; decylamine; dodecylamine; hexadecylamine; octadecylamine; dimethylamine; diethylamine; dipropylamine; di-iso-propylamine; dibutylamine; di-sec-butylamine; di-iso-butylamine; di-tert-butylamine; diisobutylamine; N,N-ethylcyclohexylamine; N-methylcyclohexylamine; N-methyl-tert-butylamine; N-methyl-iso-butylamine; N-methylpentylamine; di-allylamine; N-ethylmethylamine; N-iso-propylmethylamine; N-methylbutylamine; N-methyl-n-amylamine; N-ethyl-tert-butylamine; N-ethyl-sec-butylamine; N-ethylpropylamine; N-ethyl-iso-propylamine; N-ethyl-n-butylamine; dioctylamine; N-methyldodecylamine; propylbutylamine; N-ethylbenzylamine; 1,3-dimethylbutylamine; N,N-dimethyl-iso-propylamine; dimethylpropylamine; N,N-dimethyl-iso-butylamine; N,N-dimethyl-tert-butylamine; N,N-dimethylcyclohexylamine; N,N-dimethylethylamine; N,N-diethylmethylamine; triethylamine; di-iso-propylmethylamine; 2-(isopropylamino) ethanol; tripropylamine; trioctylamine; N,N-dimethylhexadecylamine; 1,8-diaminooctane; 1,12-diaminododecane; 1,3-dimethylamylamine; 2-aminopentane; N,N,5,5-tetramethyl-1,3-dioxan-2amine; bis[3-trimethoxysilyl)propyl]amine; octanoic acid; decanoic acid; hexanoic acid; tri-8-chlorooctylamine; trioctylamine; trioctadecylamine; or any combination thereof.

As used herein, the term “aqueous solution” refers to a solution that comprises water and has a concentration of sodium chloride (i.e., sodium ions and chloride ions when sodium chloride is in solution). In some instances, the aqueous solution comprises a concentration of sodium chloride of from about 300 mg/L to about 45,000 mg/L. In some instances, the aqueous solution has a concentration of sodium chloride of greater than about 8,500 mg/L (e.g., from about 10,000 mg/L to about 50,000 mg/L, from about 15,000 mg/L to about 45,000 mg/L, from about 20,000 mg/L to about 40,000 mg/L, or from about 27,000 mg/L to about 37,000 mg/L). The aqueous solution may comprise, by way of non-limiting example, seawater; well water; brackish water; brine; or any combination thereof.

As used herein, the term “raffinate phase” refers to the aqueous phase of a biphasic mixture that forms when a mixture of extraction agent and an aqueous solution is allowed to settle (e.g., at ambient temperature). The raffinate phase has a reduced water content and an increased concentration of sodium chloride as compared to the aqueous solution due to water absorption by the extraction agent during mixing.

As used herein, the term “wet extraction agent phase” refers to a phase comprising the extraction agent after mixing with or contacting the aqueous solution. The wet extraction agent phase has increased water content as compared to the extraction agent (or dry extraction agent) due to water absorption by the extraction agent during mixing or contacting. In some embodiments, the wet extraction agent phase has a density that is less than the density of the raffinate phase.

As used herein, the term “heated extraction agent phase” refers to a phase including the extraction agent after heating the wet extraction agent phase. The heated extraction agent phase has a reduced water content as compared to the wet extraction agent phase due to the extraction agent having reduced water solubility during heating.

As used herein, the term “heated aqueous solution phase” refers to a phase including an aqueous solution after heating the wet extraction agent phase. The heated aqueous solution phase has a concentration of sodium chloride that is less than the aqueous solution and the raffinate phase. In some embodiments, the heated extraction agent phase has a density that is less than the density of the heated aqueous solution phase.

As used herein, the term “balanced mixture” refers to a mixture of the heated extraction agent phase and the heated aqueous solution phase after removing a portion of the heated extraction agent phase. The balanced mixture has a volume ratio of from about 5:1 to about 1:10 of heated extraction agent phase to heated aqueous solution phase.

As used herein, the term “ambient temperature” refers to the temperature of the aqueous solution at its source. For example, the ambient temperature of an aqueous solution, wherein the aqueous solution is sea water, is the temperature of the sea water extracted from its source (i.e., the ocean or sea). In another example, the ambient temperature of an aqueous solution, wherein the aqueous solution is well water, is the temperature of the well water extracted from its source (i.e., the well).

As used herein, the term “cooled mixture” refers to a mixture of a cooled extraction agent phase and a cooled aqueous solution phase formed after reducing the temperature of the balanced mixture by at least 15° C.

As used herein, the term “cooled extraction agent phase” refers to a phase including the extraction agent after reducing the temperature of the balanced mixture. The cooled extraction agent phase has an increased water content as compared to the heated extraction agent phase due to water absorption by the extraction agent during cooling and/or mixing.

As used herein, the term “cooled aqueous solution phase” refers to a phase including an aqueous solution after cooling the balanced mixture. The cooled aqueous solution phase has a concentration of sodium chloride that is greater than the heated aqueous solution phase. In some embodiments, the cooled extraction agent phase has a density that is less than the density of the cooled aqueous solution phase.

As used herein, the term “concentrated extraction agent phase” refers to a phase including the cooled extraction agent phase after removing a portion of the cooled aqueous solution phase.

As used herein, the term “dry extraction agent phase” refers to a phase comprising the extraction agent after heating the concentrated extraction agent phase or concentrated wet extraction agent phase. The dry extraction agent phase has a reduced water content as compared to the concentrated extraction agent phase (or concentrated wet extraction agent phase) due to the extraction agent having reduced water solubility during heating.

As used herein, the term “water phase” refers to a phase comprising water generated from heating the concentrated extraction agent phase. In some embodiments, the water phase has a concentration of sodium chloride that is less than the aqueous solution and the heated aqueous solution phase. In some embodiments, the dry extraction agent phase has a density that is less than the density of the water phase.

As used herein, the term “diluted aqueous solution phase” refers to a phase including an aqueous solution after removing a portion of the heated extraction agent phase from the second feed mixture. In some embodiments, the diluted aqueous solution phase comprises from 0% to about 25% by volume of the heated extraction agent phase. In other embodiments, the diluted aqueous solution phase comprises from 0% to about 10% by volume of the heated extraction agent phase. And, in some embodiments, the diluted aqueous solution phase is free of the heated extraction agent phase.

As used herein, the term “second raffinate phase” refers to a phase including an aqueous solution after mixing (or contacting) the diluted aqueous solution phase with a second extraction agent. The raffinate phase has a reduced water content and an increased concentration of sodium chloride as compared to the diluted aqueous solution phase due to water absorption by the second extraction agent during mixing.

As used herein, the term “second wet extraction agent phase” refers to a phase including the second extraction agent after mixing with the diluted aqueous solution phase. The second wet extraction agent phase has increased water content as compared to the second extraction agent due to water absorption by the second extraction agent during mixing. In some embodiments, the second wet extraction agent phase has a density that is less than the density of a second raffinate phase.

As used herein, in some embodiments, the term “concentrated wet extraction agent phase” refers to a phase comprising the second wet extraction agent phase after removing at least a portion of the second raffinate phase from the second wet extraction agent phase. In some embodiments, the term “concentrated wet extraction agent phase” refers to a phase including the wet extraction agent phase after removing at least a portion of the raffinate phase from the first feed mixture. In some embodiments, the concentrated wet extraction agent phase comprises from 0% to about 25% by volume of the second raffinate phase or raffinate phase (as the case may be). In other embodiments, concentrated wet extraction agent phase comprises from 0% to about 10% by volume of the second raffinate phase or raffinate phase (as the case may be). And, in some embodiments, concentrated wet extraction agent phase is free of the second raffinate phase or raffinate phase (as the case may be).

As used herein, the term “hydroxyl” or “hydroxy” refers to an —OH moiety.

As used herein the term “aliphatic” encompasses the terms alkyl, alkenyl, and alkynyl, each of which being optionally substituted as set forth below.

As used herein, an “alkyl” group refers to a saturated aliphatic hydrocarbon group containing 1-12 (e.g., 1-8, 1-6, or 1-4) carbon atoms. An alkyl group can be straight or branched. Examples of alkyl groups include, but are not limited to, methyl, ethyl, propyl, isopropyl, butyl, isobutyl, sec-butyl, tert-butyl, n-pentyl, n-heptyl, or 2-ethylhexyl. An alkyl group can be substituted (i.e., optionally substituted) with one or more substituents such as halo, phospho, cycloaliphatic [e.g., cycloalkyl or cycloalkenyl], heterocycloaliphatic [e.g., heterocycloalkyl or heterocycloalkenyl], aryl, heteroaryl, alkoxy, aroyl, heteroaroyl, acyl [e.g., (aliphatic) carbonyl, (cycloaliphatic) carbonyl, or (heterocycloaliphatic) carbonyl], nitro, cyano, amido [e.g., (cycloalkylalkyl) carbonylamino, arylcarbonylamino, aralkylcarbonylamino, (heterocycloalkyl) carbonylamino, (heterocycloalkylalkyl) carbonylamino, heteroarylcarbonylamino, heteroaralkylcarbonylamino alkylaminocarbonyl, cycloalkylaminocarbonyl, heterocycloalkylaminocarbonyl, arylaminocarbonyl, or heteroarylaminocarbonyl], amino [e.g., aliphaticamino, cycloaliphaticamino, or heterocycloaliphaticamino], sulfonyl [e.g., aliphatic-SO₂—], sulfinyl, sulfanyl, sulfoxy, urea, thiourea, sulfamoyl, sulfamide, oxo, carboxy, carbamoyl, cycloaliphaticoxy, heterocycloaliphaticoxy, aryloxy, heteroaryloxy, aralkyloxy, heteroarylalkoxy, alkoxycarbonyl, alkylcarbonyloxy, or hydroxy. Without limitation, some examples of substituted alkyls include carboxyalkyl (such as HOOC-alkyl, alkoxycarbonylalkyl, and alkylcarbonyloxyalkyl), cyanoalkyl, hydroxyalkyl, alkoxyalkyl, acylalkyl, aralkyl, (alkoxyaryl)alkyl, (sulfonylamino)alkyl (such as (alkyl-SO₂-amino)alkyl), aminoalkyl, amidoalkyl, (cycloaliphatic)alkyl, or haloalkyl.

As used herein, an “alkenyl” group refers to an aliphatic carbon group that contains 2-8 (e.g., 2-12, 2-6, or 2-4) carbon atoms and at least one double bond. Like an alkyl group, an alkenyl group can be straight or branched. Examples of an alkenyl group include, but are not limited to allyl, 1- or 2-isopropenyl, 2-butenyl, and 2-hexenyl. An alkenyl group can be optionally substituted with one or more substituents such as halo, phospho, cycloaliphatic [e.g., cycloalkyl or cycloalkenyl], heterocycloaliphatic [e.g., heterocycloalkyl or heterocycloalkenyl], aryl, heteroaryl, alkoxy, aroyl, heteroaroyl, acyl [e.g., (aliphatic) carbonyl, (cycloaliphatic) carbonyl, or (heterocycloaliphatic) carbonyl], nitro, cyano, amido [e.g., (cycloalkylalkyl) carbonylamino, arylcarbonylamino, aralkylcarbonylamino, (heterocycloalkyl) carbonylamino, (heterocycloalkylalkyl) carbonylamino, heteroarylcarbonylamino, heteroaralkylcarbonylamino alkylaminocarbonyl, cycloalkylaminocarbonyl, heterocycloalkylaminocarbonyl, arylaminocarbonyl, or heteroarylaminocarbonyl], amino [e.g., aliphaticamino, cycloaliphaticamino, heterocycloaliphaticamino, or aliphaticsulfonylamino], sulfonyl [e.g., alkyl-SO₂—, cycloaliphatic-SO₂—, or aryl-SO₂—], sulfinyl, sulfanyl, sulfoxy, urea, thiourea, sulfamoyl, sulfamide, oxo, carboxy, carbamoyl, cycloaliphaticoxy, heterocycloaliphaticoxy, aryloxy, heteroaryloxy, aralkyloxy, heteroaralkoxy, alkoxycarbonyl, alkylcarbonyloxy, or hydroxy. Without limitation, some examples of substituted alkenyls include cyanoalkenyl, alkoxyalkenyl, acylalkenyl, hydroxyalkenyl, aralkenyl, (alkoxyaryl)alkenyl, (sulfonylamino)alkenyl (such as (alkyl-SO₂-amino)alkenyl), aminoalkenyl, amidoalkenyl, (cycloaliphatic)alkenyl, or haloalkenyl.

As used herein, an “alkynyl” group refers to an aliphatic carbon group that contains 2-8 (e.g., 2-12, 2-6, or 2-4) carbon atoms and has at least one triple bond. An alkynyl group can be straight or branched. Examples of an alkynyl group include, but are not limited to, propargyl and butynyl. An alkynyl group can be optionally substituted with one or more substituents such as aroyl, heteroaroyl, alkoxy, cycloalkyloxy, heterocycloalkyloxy, aryloxy, heteroaryloxy, aralkyloxy, nitro, carboxy, cyano, halo, hydroxy, sulfo, mercapto, sulfanyl [e.g., aliphaticsulfanyl or cycloaliphaticsulfanyl], sulfinyl [e.g., aliphaticsulfinyl or cycloaliphaticsulfinyl], sulfonyl [e.g., aliphatic-SO₂—, aliphaticamino-SO₂—, or cycloaliphatic-SO₂—], amido [e.g., aminocarbonyl, alkylaminocarbonyl, alkylcarbonylamino, cycloalkylaminocarbonyl, heterocycloalkylaminocarbonyl, cycloalkylcarbonylamino, arylaminocarbonyl, arylcarbonylamino, aralkylcarbonylamino, (heterocycloalkyl) carbonylamino, (cycloalkylalkyl) carbonylamino, heteroaralkylcarbonylamino, heteroarylcarbonylamino or heteroarylaminocarbonyl], urea, thiourea, sulfamoyl, sulfamide, alkoxycarbonyl, alkylcarbonyloxy, cycloaliphatic, heterocycloaliphatic, aryl, heteroaryl, acyl [e.g., (cycloaliphatic) carbonyl or (heterocycloaliphatic) carbonyl], amino [e.g., aliphaticamino], sulfoxy, oxo, carboxy, carbamoyl, (cycloaliphatic)oxy, (heterocycloaliphatic)oxy, or (heteroaryl)alkoxy.

As used herein, an “amido” encompasses both “aminocarbonyl” and “carbonylamino.” These terms when used alone or in connection with another group refer to an amido group such as —N(R^{X})—C(O)—R^{Y} or —C(O)—N(R^{X})₂, when used terminally, and —C(O)—N(R^{X})— or —N(R^{X})—C(O)— when used internally, wherein R^{X} and R^{Y} can be aliphatic, cycloaliphatic, aryl, araliphatic, heterocycloaliphatic, heteroaryl or heteroaraliphatic. Examples of amido groups include alkylamido (such as alkylcarbonylamino or alkylaminocarbonyl), (heterocycloaliphatic)amido, (heteroaralkyl)amido, (heteroaryl)amido, (heterocycloalkyl)alkylamido, arylamido, aralkylamido, (cycloalkyl)alkylamido, or cycloalkylamido.

As used herein, an “amino” group refers to —NR^{X}R^{Y} wherein each of R^{X} and R^{Y} is independently hydrogen, aliphatic, cycloaliphatic, (cycloaliphatic) aliphatic, aryl, araliphatic, heterocycloaliphatic, (heterocycloaliphatic) aliphatic, heteroaryl, carboxy, sulfanyl, sulfinyl, sulfonyl, (aliphatic) carbonyl, (cycloaliphatic) carbonyl, ((cycloaliphatic) aliphatic) carbonyl, arylcarbonyl, (araliphatic) carbonyl, (heterocycloaliphatic) carbonyl, ((heterocycloaliphatic) aliphatic) carbonyl, (heteroaryl) carbonyl, or (heteroaraliphatic) carbonyl, each of which being defined herein and being optionally substituted. Examples of amino groups include alkylamino, dialkylamino, or arylamino. When the term “amino” is not the terminal group (e.g., alkylcarbonylamino), it is represented by —NR^{X}—, where R^{X} has the same meaning as defined above.

As used herein, an “aryl” group used alone or as part of a larger moiety as in “aralkyl,” “aralkoxy,” or “aryloxyalkyl” refers to monocyclic (e.g., phenyl); bicyclic (e.g., indenyl, naphthalenyl, tetrahydronaphthyl, tetrahydroindenyl); and tricyclic (e.g., fluorenyl tetrahydrofluorenyl, or tetrahydroanthracenyl, anthracenyl) ring systems in which the monocyclic ring system is aromatic or at least one of the rings in a bicyclic or tricyclic ring system is aromatic. The bicyclic and tricyclic groups include benzofused 2-3 membered carbocyclic rings. For example, a benzofused group includes phenyl fused with two or more C₄₋₈ carbocyclic moieties. An aryl is optionally substituted with one or more substituents including aliphatic [e.g., alkyl, alkenyl, or alkynyl]; cycloaliphatic; (cycloaliphatic) aliphatic; heterocycloaliphatic; (heterocycloaliphatic) aliphatic; aryl; heteroaryl; alkoxy; (cycloaliphatic)oxy; (heterocycloaliphatic)oxy; aryloxy; heteroaryloxy; (araliphatic)oxy; (heteroaraliphatic)oxy; aroyl; heteroaroyl; amino; oxo (on a non-aromatic carbocyclic ring of a benzofused bicyclic or tricyclic aryl); nitro; carboxy; amido; acyl [e.g., (aliphatic) carbonyl; (cycloaliphatic) carbonyl; ((cycloaliphatic) aliphatic) carbonyl; (araliphatic) carbonyl; (heterocycloaliphatic) carbonyl; ((heterocycloaliphatic) aliphatic) carbonyl; or (heteroaraliphatic) carbonyl]; sulfonyl [e.g., aliphatic-SO₂— or amino-SO₂—]; sulfinyl [e.g., aliphatic-S(O)— or cycloaliphatic-S(O)—]; sulfanyl [e.g., aliphatic-S—]; cyano; halo; hydroxy; mercapto; sulfoxy; urea; thiourea; sulfamoyl; sulfamide; or carbamoyl. Alternatively, an aryl can be unsubstituted.

Non-limiting examples of substituted aryls include haloaryl [e.g., mono-, di (such as p,m-dihaloaryl), and (trihalo) aryl]; (carboxy) aryl [e.g., (alkoxycarbonyl) aryl, ((aralkyl) carbonyloxy) aryl, and (alkoxycarbonyl) aryl]; (amido) aryl [e.g., (aminocarbonyl) aryl, (((alkylamino)alkyl)aminocarbonyl) aryl, (alkylcarbonyl)aminoaryl, (arylaminocarbonyl) aryl, and (((heteroaryl)amino) carbonyl) aryl]; aminoaryl [e.g., ((alkylsulfonyl)amino) aryl or ((dialkyl)amino) aryl]; (cyanoalkyl) aryl; (alkoxy) aryl; (sulfamoyl) aryl [e.g., (aminosulfonyl) aryl]; (alkylsulfonyl) aryl; (cyano) aryl; (hydroxyalkyl) aryl; ((alkoxy)alkyl) aryl; (hydroxy) aryl, ((carboxy)alkyl) aryl; (((dialkyl)amino)alkyl) aryl; (nitroalkyl) aryl; (((alkylsulfonyl)amino)alkyl) aryl; ((heterocycloaliphatic) carbonyl) aryl; ((alkylsulfonyl)alkyl) aryl; (cyanoalkyl) aryl; (hydroxyalkyl) aryl; (alkylcarbonyl) aryl; alkylaryl; (trihaloalkyl) aryl; p-amino-m-alkoxycarbonylaryl; p-amino-m-cyanoaryl; p-halo-m-aminoaryl; or (m-(heterocycloaliphatic)-o-(alkyl)) aryl.

As used herein, an “araliphatic” such as an “aralkyl” group refers to an aliphatic group (e.g., a C₁₋₄ alkyl group) that is substituted with an aryl group. “Aliphatic,” “alkyl,” and “aryl” are defined herein. An example of an araliphatic such as an aralkyl group is benzyl.

As used herein, an “aralkyl” group refers to an alkyl group (e.g., a C₁₋₄ alkyl group) that is substituted with an aryl group. Both “alkyl” and “aryl” have been defined above. An example of an aralkyl group is benzyl. An aralkyl is optionally substituted with one or more substituents such as aliphatic [e.g., alkyl, alkenyl, or alkynyl, including carboxyalkyl, hydroxyalkyl, or haloalkyl such as trifluoromethyl], cycloaliphatic [e.g., cycloalkyl or cycloalkenyl], (cycloalkyl)alkyl, heterocycloalkyl, (heterocycloalkyl)alkyl, aryl, heteroaryl, alkoxy, cycloalkyloxy, heterocycloalkyloxy, aryloxy, heteroaryloxy, aralkyloxy, heteroaralkyloxy, aroyl, heteroaroyl, nitro, carboxy, alkoxycarbonyl, alkylcarbonyloxy, amido [e.g., aminocarbonyl, alkylcarbonylamino, cycloalkylcarbonylamino, (cycloalkylalkyl) carbonylamino, arylcarbonylamino, aralkylcarbonylamino, (heterocycloalkyl) carbonylamino, (heterocycloalkylalkyl) carbonylamino, heteroarylcarbonylamino, or heteroaralkylcarbonylamino], cyano, halo, hydroxy, acyl, mercapto, alkylsulfanyl, sulfoxy, urea, thiourea, sulfamoyl, sulfamide, oxo, or carbamoyl.

As used herein, a “bicyclic ring system” includes 6-12 (e.g., 8-12 or 9, 10, or 11) membered structures that form two rings, wherein the two rings have at least one atom in common (e.g., 2 atoms in common). Bicyclic ring systems include bicycloaliphatics (e.g., bicycloalkyl or bicycloalkenyl), bicycloheteroaliphatics, bicyclic aryls, and bicyclic heteroaryls.

As used herein, a “cycloaliphatic” group encompasses a “cycloalkyl” group and a “cycloalkenyl” group, each of which being optionally substituted as set forth below.

As used herein, a “cycloalkyl” group refers to a saturated carbocyclic mono- or bicyclic (fused or bridged) ring of 3-10 (e.g., 5-10) carbon atoms. Examples of cycloalkyl groups include cyclopropyl, cyclobutyl, cyclopentyl, cyclohexyl, cycloheptyl, adamantyl, norbornyl, cubyl, octahydro-indenyl, decahydro-naphthyl, bicyclo[3.2.1]octyl, bicyclo[2.2.2]octyl, bicyclo[3.3.1]nonyl, bicyclo[3.3.2.]decyl, bicyclo[2.2.2]octyl, adamantyl, or ((aminocarbonyl)cycloalkyl)cycloalkyl.

A “cycloalkenyl” group, as used herein, refers to a non-aromatic carbocyclic ring of 3-10 (e.g., 4-8) carbon atoms having one or more double bonds. Examples of cycloalkenyl groups include cyclopentenyl, 1,4-cyclohexa-di-enyl, cycloheptenyl, cyclooctenyl, hexahydro-indenyl, octahydro-naphthyl, cyclohexenyl, bicyclo[2.2.2]octenyl, or bicyclo[3.3.1]nonenyl.

A cycloalkyl or cycloalkenyl group can be optionally substituted with one or more substituents such as phospho, aliphatic [e.g., alkyl, alkenyl, or alkynyl], cycloaliphatic, (cycloaliphatic) aliphatic, heterocycloaliphatic, (heterocycloaliphatic) aliphatic, aryl, heteroaryl, alkoxy, (cycloaliphatic)oxy, (heterocycloaliphatic)oxy, aryloxy, heteroaryloxy, (araliphatic)oxy, (heteroaraliphatic)oxy, aroyl, heteroaroyl, amino, amido [e.g., (aliphatic) carbonylamino, (cycloaliphatic) carbonylamino, ((cycloaliphatic) aliphatic) carbonylamino, (aryl) carbonylamino, (araliphatic) carbonylamino, (heterocycloaliphatic) carbonylamino, ((heterocycloaliphatic) aliphatic) carbonylamino, (heteroaryl) carbonylamino, or (heteroaraliphatic) carbonylamino], nitro, carboxy [e.g., HOOC—, alkoxycarbonyl, or alkylcarbonyloxy], acyl [e.g., (cycloaliphatic) carbonyl, ((cycloaliphatic) aliphatic) carbonyl, (araliphatic) carbonyl, (heterocycloaliphatic) carbonyl, ((heterocycloaliphatic) aliphatic) carbonyl, or (heteroaraliphatic) carbonyl], cyano, halo, hydroxy, mercapto, sulfonyl [e.g., alkyl-SO₂— and aryl-SO₂—], sulfinyl [e.g., alkyl-S(O)—], sulfanyl [e.g., alkyl-S—], sulfoxy, urea, thiourea, sulfamoyl, sulfamide, oxo, or carbamoyl.

As used herein, the term “heterocycloaliphatic” encompasses heterocycloalkyl groups and heterocycloalkenyl groups, each of which being optionally substituted as set forth below.

As used herein, a “heterocycloalkyl” group refers to a 3-10 membered mono- or bicylic (fused or bridged) (e.g., 5- to 10-membered mono- or bicyclic) saturated ring structure, in which one or more of the ring atoms is a heteroatom (e.g., N, O, S, or combinations thereof). Examples of a heterocycloalkyl group include piperidyl, piperazyl, tetrahydropyranyl, tetrahydrofuryl, 1,4-dioxolanyl, 1,4-dithianyl, 1,3-dioxolanyl, oxazolidyl, isoxazolidyl, morpholinyl, thiomorpholyl, octahydrobenzofuryl, octahydrochromenyl, octahydrothiochromenyl, octahydroindolyl, octahydropyrindinyl, decahydroquinolinyl, octahydrobenzo[b]thiopheneyl, 2-oxa-bicyclo [2.2.2]octyl, 1-aza-bicyclo [2.2.2]octyl, 3-aza-bicyclo [3.2.1]octyl, and 2,6-dioxa-tricyclo [3.3.1.0^{3,7}]nonyl. A monocyclic heterocycloalkyl group can be fused with a phenyl moiety to form structures, such as tetrahydroisoquinoline, that would be categorized as heteroaryls.

A “heterocycloalkenyl” group, as used herein, refers to a mono- or bicylic (e.g., 5- to 10-membered mono- or bicyclic) non-aromatic ring structure having one or more double bonds, and wherein one or more of the ring atoms is a heteroatom (e.g., N, O, or S). Monocyclic and bicyclic heterocycloaliphatics are numbered according to standard chemical nomenclature.

A heterocycloalkyl or heterocycloalkenyl group can be optionally substituted with one or more substituents such as phospho, aliphatic [e.g., alkyl, alkenyl, or alkynyl], cycloaliphatic, (cycloaliphatic) aliphatic, heterocycloaliphatic, (heterocycloaliphatic) aliphatic, aryl, heteroaryl, alkoxy, (cycloaliphatic)oxy, (heterocycloaliphatic)oxy, aryloxy, heteroaryloxy, (araliphatic)oxy, (heteroaraliphatic)oxy, aroyl, heteroaroyl, amino, amido [e.g., (aliphatic) carbonylamino, (cycloaliphatic) carbonylamino, ((cycloaliphatic) aliphatic) carbonylamino, (aryl) carbonylamino, (araliphatic) carbonylamino, (heterocycloaliphatic) carbonylamino, ((heterocycloaliphatic) aliphatic) carbonylamino, (heteroaryl) carbonylamino, or (heteroaraliphatic) carbonylamino], nitro, carboxy [e.g., HOOC—, alkoxycarbonyl, or alkylcarbonyloxy], acyl [e.g., (cycloaliphatic) carbonyl, ((cycloaliphatic) aliphatic) carbonyl, (araliphatic) carbonyl, (heterocycloaliphatic) carbonyl, ((heterocycloaliphatic) aliphatic) carbonyl, or (heteroaraliphatic) carbonyl], nitro, cyano, halo, hydroxy, mercapto, sulfonyl [e.g., alkylsulfonyl or arylsulfonyl], sulfinyl [e.g., alkylsulfinyl], sulfanyl [e.g., alkylsulfanyl], sulfoxy, urea, thiourea, sulfamoyl, sulfamide, oxo, or carbamoyl.

A “heteroaryl” group, as used herein, refers to a monocyclic, bicyclic, or tricyclic ring system having 4 to 15 ring atoms wherein one or more of the ring atoms is a heteroatom (e.g., N, O, S, or combinations thereof) and in which the monocyclic ring system is aromatic or at least one of the rings in the bicyclic or tricyclic ring systems is aromatic. A heteroaryl group includes a benzofused ring system having 2 to 3 rings. For example, a benzofused group includes benzo fused with one or two 4 to 8 membered heterocycloaliphatic moieties (e.g., indolizyl, indolyl, isoindolyl, 3H-indolyl, indolinyl, benzo[b]furyl, benzo[b]thiophene-yl, quinolinyl, or isoquinolinyl). Some examples of heteroaryl are azetidinyl, pyridyl, 1H-indazolyl, furyl, pyrrolyl, thienyl, thiazolyl, oxazolyl, imidazolyl, tetrazolyl, benzofuryl, isoquinolinyl, benzthiazolyl, xanthene, thioxanthene, phenothiazine, dihydroindole, benzo[1,3]dioxole, benzo[b]furyl, benzo[b]thiophenyl, indazolyl, benzimidazolyl, benzthiazolyl, puryl, cinnolyl, quinolyl, quinazolyl, cinnolyl, phthalazyl, quinazolyl, quinoxalyl, isoquinolyl, 4H-quinolizyl, benzo-1,2,5-thiadiazolyl, or 1,8-naphthyridyl.

Without limitation, monocyclic heteroaryls include furyl, thiophene-yl, 2H-pyrrolyl, pyrrolyl, oxazolyl, thazolyl, imidazolyl, pyrazolyl, isoxazolyl, isothiazolyl, 1,3,4-thiadiazolyl, 2H-pyranyl, 4-H-pranyl, pyridyl, pyridazyl, pyrimidyl, pyrazolyl, pyrazyl, or 1,3,5-triazyl. Monocyclic heteroaryls are numbered according to standard chemical nomenclature.

Without limitation, bicyclic heteroaryls include indolizyl, indolyl, isoindolyl, 3H-indolyl, indolinyl, benzo[b]furyl, benzo[b]thiophenyl, quinolinyl, isoquinolinyl, indolizyl, isoindolyl, indolyl, benzo[b]furyl, bexo [b]thiophenyl, indazolyl, benzimidazyl, benzthiazolyl, purinyl, 4H-quinolizyl, quinolyl, isoquinolyl, cinnolyl, phthalazyl, quinazolyl, quinoxalyl, 1,8-naphthyridyl, or pteridyl. Bicyclic heteroaryls are numbered according to standard chemical nomenclature.

A heteroaryl is optionally substituted with one or more substituents such as aliphatic [e.g., alkyl, alkenyl, or alkynyl]; cycloaliphatic; (cycloaliphatic) aliphatic; heterocycloaliphatic; (heterocycloaliphatic) aliphatic; aryl; heteroaryl; alkoxy; (cycloaliphatic)oxy; (heterocycloaliphatic)oxy; aryloxy; heteroaryloxy; (araliphatic)oxy; (heteroaraliphatic)oxy; aroyl; heteroaroyl; amino; oxo (on a non-aromatic carbocyclic or heterocyclic ring of a bicyclic or tricyclic heteroaryl); carboxy; amido; acyl [e.g., aliphaticcarbonyl; (cycloaliphatic) carbonyl; ((cycloaliphatic) aliphatic) carbonyl; (araliphatic) carbonyl; (heterocycloaliphatic) carbonyl; ((heterocycloaliphatic) aliphatic) carbonyl; or (heteroaraliphatic) carbonyl]; sulfonyl [e.g., aliphaticsulfonyl or aminosulfonyl]; sulfinyl [e.g., aliphaticsulfinyl]; sulfanyl [e.g., aliphaticsulfanyl]; nitro; cyano; halo; hydroxy; mercapto; sulfoxy; urea; thiourea; sulfamoyl; sulfamide; or carbamoyl. Alternatively, a heteroaryl can be unsubstituted.

Non-limiting examples of substituted heteroaryls include (halo) heteroaryl [e.g., mono- and di-(halo) heteroaryl]; (carboxy) heteroaryl [e.g., (alkoxycarbonyl) heteroaryl]; cyanoheteroaryl; aminoheteroaryl [e.g., ((alkylsulfonyl)amino)heteroaryl and ((dialkyl)amino)heteroaryl]; (amido)heteroaryl [e.g., aminocarbonylheteroaryl, ((alkylcarbonyl)amino)heteroaryl, ((((alkyl)amino)alkyl)aminocarbonyl)heteroaryl, (((heteroaryl)amino)carbonyl)heteroaryl, ((heterocycloaliphatic)carbonyl)heteroaryl, and ((alkylcarbonyl)amino)heteroaryl]; (cyanoalkyl)heteroaryl; (alkoxy)heteroaryl; (sulfamoyl)heteroaryl [e.g., (aminosulfonyl)heteroaryl]; (sulfonyl)heteroaryl [e.g., (alkylsulfonyl)heteroaryl]; (hydroxyalkyl)heteroaryl; (alkoxyalkyl)heteroaryl; (hydroxy)heteroaryl; ((carboxy)alkyl)heteroaryl; (((dialkyl)amino)alkyl]heteroaryl; (heterocycloaliphatic)heteroaryl; (cycloaliphatic)heteroaryl; (nitroalkyl)heteroaryl; (((alkylsulfonyl)amino)alkyl)heteroaryl; ((alkylsulfonyl)alkyl)heteroaryl; (cyanoalkyl)heteroaryl; (acyl)heteroaryl [e.g., (alkylcarbonyl)heteroaryl]; (alkyl)heteroaryl; or (haloalkyl)heteroaryl [e.g., trihaloalkylheteroaryl].

As used herein, a “heteroaraliphatic” (such as a heteroaralkyl group) refers to an aliphatic group (e.g., a C₁₋₄ alkyl group) that is substituted with a heteroaryl group. “Aliphatic,” “alkyl,” and “heteroaryl” have been defined above.

As used herein, a “heteroaralkyl” group refers to an alkyl group (e.g., a C₁₋₄ alkyl group) that is substituted with a heteroaryl group. Both “alkyl” and “heteroaryl” have been defined above. A heteroaralkyl is optionally substituted with one or more substituents such as alkyl (including carboxyalkyl, hydroxyalkyl, and haloalkyl such as trifluoromethyl), alkenyl, alkynyl, cycloalkyl, (cycloalkyl)alkyl, heterocycloalkyl, (heterocycloalkyl)alkyl, aryl, heteroaryl, alkoxy, cycloalkyloxy, heterocycloalkyloxy, aryloxy, heteroaryloxy, aralkyloxy, heteroaralkyloxy, aroyl, heteroaroyl, nitro, carboxy, alkoxycarbonyl, alkylcarbonyloxy, aminocarbonyl, alkylcarbonylamino, cycloalkylcarbonylamino, (cycloalkylalkyl) carbonylamino, arylcarbonylamino, aralkylcarbonylamino, (heterocycloalkyl) carbonylamino, (heterocycloalkylalkyl) carbonylamino, heteroarylcarbonylamino, heteroaralkylcarbonylamino, cyano, halo, hydroxy, acyl, mercapto, alkylsulfanyl, sulfoxy, urea, thiourea, sulfamoyl, sulfamide, oxo, or carbamoyl.

As used herein, “cyclic moiety” and “cyclic group” refer to mono-, bi-, and tri-cyclic ring systems including cycloaliphatic, heterocycloaliphatic, aryl, or heteroaryl, each of which has been previously defined.

As used herein, a “bridged bicyclic ring system” refers to a bicyclic heterocyclicalipahtic ring system or bicyclic cycloaliphatic ring system in which the rings are bridged. Examples of bridged bicyclic ring systems include, but are not limited to, adamantanyl, norbornanyl, bicyclo[3.2.1]octyl, bicyclo[2.2.2]octyl, bicyclo[3.3.1]nonyl, bicyclo[3.3.2]decyl, 2-oxabicyclo [2.2.2]octyl, 1-azabicyclo [2.2.2]octyl, 3-azabicyclo [3.2.1]octyl, and 2,6-dioxa-tricyclo [3.3.1.0^{3,7}]nonyl. A bridged bicyclic ring system can be optionally substituted with one or more substituents such as alkyl (including carboxyalkyl, hydroxyalkyl, and haloalkyl such as trifluoromethyl), alkenyl, alkynyl, cycloalkyl, (cycloalkyl)alkyl, heterocycloalkyl, (heterocycloalkyl)alkyl, aryl, heteroaryl, alkoxy, cycloalkyloxy, heterocycloalkyloxy, aryloxy, heteroaryloxy, aralkyloxy, heteroaralkyloxy, aroyl, heteroaroyl, nitro, carboxy, alkoxycarbonyl, alkylcarbonyloxy, aminocarbonyl, alkylcarbonylamino, cycloalkylcarbonylamino, (cycloalkylalkyl) carbonylamino, arylcarbonylamino, aralkylcarbonylamino, (heterocycloalkyl) carbonylamino, (heterocycloalkylalkyl) carbonylamino, heteroarylcarbonylamino, heteroaralkylcarbonylamino, cyano, halo, hydroxy, acyl, mercapto, alkylsulfanyl, sulfoxy, urea, thiourea, sulfamoyl, sulfamide, oxo, or carbamoyl.

As used herein, an “acyl” group refers to a formyl group or R^{X}—C(O)— (such as alkyl-C(O)—, also referred to as “alkylcarbonyl”) where R^{X} and “alkyl” have been defined previously. Acetyl and pivaloyl are examples of acyl groups.

As used herein, an “aroyl” or “heteroaroyl” refers to an aryl-C(O)— or a heteroaryl-C(O)—. The aryl and heteroaryl portion of the aroyl or heteroaroyl is optionally substituted as previously defined.

As used herein, an “alkoxy” group refers to an alkyl-O— group where “alkyl” has been defined previously.

As used herein, a “carbamoyl” group refers to a group having the structure —O—CO—NR^{X}R^{Y} or —NR^{X}—CO—O—R^{Z}, wherein R^{X} and R^{Y} have been defined above and R^{Z} can be aliphatic, aryl, araliphatic, heterocycloaliphatic, heteroaryl, or heteroaraliphatic.

As used herein, a “carboxy” group refers to —COOH, —COOR^{X}, —OC(O)H, —OC(O)R^{X}, when used as a terminal group; or —OC(O)— or —C(O)O— when used as an internal group.

As used herein, a “haloaliphatic” group refers to an aliphatic group substituted with 1-3 halogen. For instance, the term haloalkyl includes the group —CF₃.

As used herein, a “mercapto” group refers to —SH.

As used herein, a “sulfo” group refers to —SO₃H or —SO₃R^{X} when used terminally or —S(O)₃— when used internally.

As used herein, a “sulfamide” group refers to the structure —NR^{X}—S(O)₂—NR^{Y}R^{Z} when used terminally and —NR^{X}—S(O)₂—NR^{Y}— when used internally, wherein R^{X}, R^{Y}, and R^{Z} have been defined above.

As used herein, a “sulfamoyl” group refers to the structure-O—S(O)₂—NR^{Y}R^{Z} wherein R^{Y} and R^{Z} have been defined above.

As used herein, a “sulfonamide” group refers to the structure —S(O)₂—NR^{X}R^{Y} or —NR^{X}—S(O)₂—R^{Z} when used terminally; or —S(O)₂—NR^{X}— or —NR^{X}—S(O)₂— when used internally, wherein R^{X}, R^{Y}, and R^{Z} are defined above.

As used herein a “sulfanyl” group refers to —S—R^{X} when used terminally and —S— when used internally, wherein R^{X} has been defined above. Examples of sulfanyls include aliphatic-S—, cycloaliphatic-S—, aryl-S—, or the like.

As used herein a “sulfinyl” group refers to —S(O)—R^{X} when used terminally and —S(O)— when used internally, wherein R^{X} has been defined above. Examples of sulfinyl groups include aliphatic-S(O)—, aryl-S(O)—, (cycloaliphatic (aliphatic))-S(O)—, cycloalkyl-S(O)—, heterocycloaliphatic-S(O)—, heteroaryl-S(O)—, or the like.

As used herein, a “sulfonyl” group refers to —S(O)₂—R^{X} when used terminally and —S(O)₂— when used internally, wherein R^{X} has been defined above. Examples of sulfonyl groups include aliphatic-S(O)₂—, aryl-S(O)₂—, (cycloaliphatic (aliphatic))-S(O)₂—, cycloaliphatic-S(O)₂—, heterocycloaliphatic-S(O)₂—, heteroaryl-S(O)₂—, (cycloaliphatic (amido (aliphatic)))-S(O)₂— or the like.

As used herein, a “sulfoxy” group refers to —O—S(O)—R^{X} or —S(O)—O—R^{X}, when used terminally and —O—S(O)— or —S(O)—O— when used internally, where R^{X} has been defined above.

As used herein, a “halogen” or “halo” group refers to fluorine, chlorine, bromine or iodine.

As used herein, an “alkoxycarbonyl,” which is encompassed by the term carboxy, used alone or in connection with another group refers to a group such as alkyl-O—C(O)—.

As used herein, an “alkoxyalkyl” refers to an alkyl group such as alkyl-O-alkyl-, wherein alkyl has been defined above.

As used herein, a “carbonyl” refers to —C(O)—.

As used herein, an “oxo” refers to ═O.

As used herein, the term “phospho” refers to phosphinates and phosphonates.

Examples of phosphinates and phosphonates include —P(O)(R^{P})₂, wherein R^{P} is aliphatic, alkoxy, aryloxy, heteroaryloxy, (cycloaliphatic)oxy, (heterocycloaliphatic)oxy aryl, heteroaryl, cycloaliphatic or amino.

As used herein, an “aminoalkyl” refers to the structure (R^{X})₂N-alkyl-.

As used herein, a “cyanoalkyl” refers to the structure (NC)-alkyl-.

As used herein, a “urea” group refers to the structure-NR^{X}—CO—NR^{Y}R^{Z} and a “thiourea” group refers to the structure —NR^{X}—CS—NR^{Y}R^{Z} when used terminally and —NR^{X}—CO—NR^{Y}— or —NR^{X}—CS—NR^{Y}-when used internally, wherein R^{X}, R^{Y}, and R^{Z} have been defined above.

As used herein, a “guanidine” group refers to the structure —N═C(N(R^{X}R^{Y})) N(R^{X}R^{Y}) or —NR^{X}—C(═NR^{X}) NR^{X}R^{Y} wherein R^{X} and R^{Y} have been defined above.

As used herein, the term “amidino” group refers to the structure —C═(NR^{X}) N(R^{X}R^{Y}) wherein R^{X} and R^{Y} have been defined above.

As used herein, the term “vicinal” generally refers to the placement of substituents on a group that includes two or more carbon atoms, wherein the substituents are attached to adjacent carbon atoms.

As used herein, the term “geminal” generally refers to the placement of substituents on a group that includes two or more carbon atoms, wherein the substituents are attached to the same carbon atom.

The terms “terminally” and “internally” refer to the location of a group within a substituent. A group is terminal when the group is present at the end of the substituent not further bonded to the rest of the chemical structure. Carboxyalkyl, i.e., R^{X}O(O)C-alkyl, is an example of a carboxy group used terminally. A group is internal when the group is present in the middle of a substituent of the chemical structure. Alkylcarboxy (e.g., alkyl-C(O)O— or alkyl-OC(O)—) and alkylcarboxyaryl (e.g., alkyl-C(O)O-aryl- or alkyl-O(CO)-aryl-) are examples of carboxy groups used internally.

As used herein, an “aliphatic chain” refers to a branched or straight aliphatic group (e.g., alkyl groups, alkenyl groups, or alkynyl groups). A straight aliphatic chain has the structure-[CH₂]ᵥ—, where v is 1-12. A branched aliphatic chain is a straight aliphatic chain that is substituted with one or more aliphatic groups. A branched aliphatic chain has the structure-[CQQ]ᵥ— where Q is independently a hydrogen or an aliphatic group; however, Q shall be an aliphatic group in at least one instance. The term aliphatic chain includes alkyl chains, alkenyl chains, and alkynyl chains, where alkyl, alkenyl, and alkynyl are defined above.

The phrase “optionally substituted” is used herein interchangeably with the phrase “substituted or unsubstituted.”

As used herein, the term “substituted,” whether preceded by the term “optionally” or not, refers generally to the replacement of hydrogen atoms in a given structure with the radical of a specified substituent. Specific substituents are described above in the definitions and below in the description of compounds and examples thereof. Unless otherwise indicated, an optionally substituted group can have a substituent at each substitutable position of the group, and when more than one position in any given structure can be substituted with more than one substituent selected from a specified group, the substituent can be either the same or different at every position. A ring substituent, such as a heterocycloalkyl, can be bound to another ring, such as a cycloalkyl, to form a spiro-bicyclic ring system, e.g., both rings share one common atom. As one of ordinary skill in the art will recognize, combinations of substituents envisioned by this invention are those combinations that result in the formation of stable or chemically feasible compounds.

### II. Balancer for Extracting Water from an Aqueous Solution

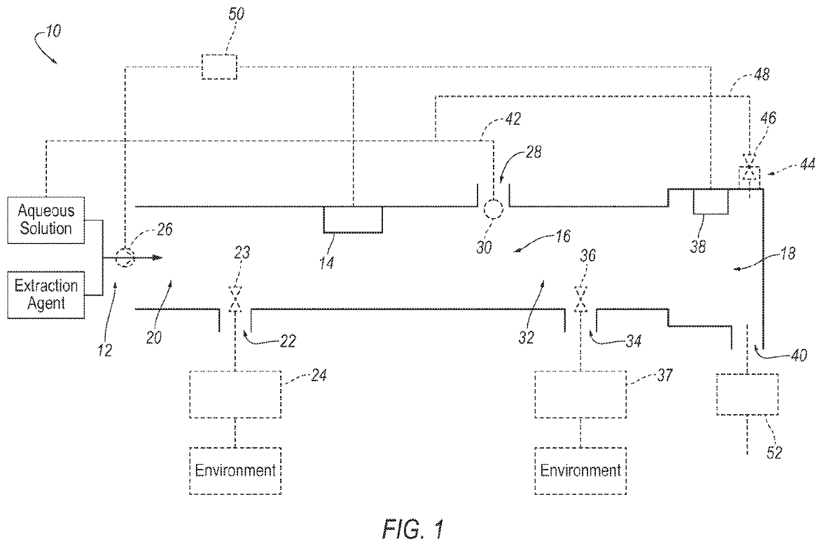

In one aspect, the present invention provides a balancer for extracting water from an aqueous solution. Referring to FIG. 1, the balancer 10 comprises a first feed stream 12, a first heater 14, a second feed stream 16, and an extractor 18.

### A. First Feed Stream

The first feed stream comprises a first stream channel 20 and a first stream outlet 22. The first stream channel is configured to mix an extraction agent and an aqueous solution under ambient temperature to form a wet extraction phase and a raffinate phase. The density of the wet extraction agent phase is less than the density of the raffinate phase. The aqueous solution has a concentration of sodium chloride. The raffinate phase has a reduced water content and an increased concentration of sodium chloride as compared to the aqueous solution due to water absorption by the extraction agent during mixing. The wet extraction agent phase has increased water content as compared to the extraction agent due to water absorption by the extraction agent during mixing. In some embodiments, the first stream channel is configured to contact a stream of extraction agent with a stream of aqueous solution.

In some embodiments, the first stream channel is configured to mix the extraction agent and the aqueous solution for a period of from about 1 second to about 5 minutes (e.g., from about 3 seconds to about 5 minutes, from about 30 seconds to about 2 minutes, from about 5 seconds to about 1.5 minutes, from about 30 seconds to about 1.5 minutes, from about 10 seconds to about 30 seconds, or from about 5 seconds to about 2 minutes, or for about 1 minute).

The first stream outlet is configured to permit at least a portion of the raffinate phase to exit the first stream channel and form a reduced first feed stream. The reduced first feed stream has a volume ratio of wet extraction agent phase to raffinate phase that is greater than the first feed stream due to the removal of the portion of the raffinate phase from the first stream channel. In some embodiments, as shown in FIG. 1, the first stream outlet is configured to permit the portion of the raffinate phase exiting the first stream channel to be released into the environment. In some embodiments, the first stream outlet comprises a valve 23 fluidly coupled to the first stream channel. The valve may be any valve suitable for permitting a portion of the raffinate phase to exit the first stream channel.

With continued reference to FIG. 1, in some embodiments, the balancer further comprises a sparging tank 24. When present, the sparging tank fluidly communicates with the first stream outlet and is configured to sparge at least a portion of the raffinate phase to remove extraction agent from the raffinate phase. In this manner, the raffinate phase can be released into the environment substantially free (e.g., (e.g., comprising less than 1% by volume, comprising less than 0.5% by volume, or comprising less than 0.1% by volume) or free of the extraction agent. In some embodiments, in addition to or in place of the sparging tank, the balancer comprises a granular activated carbon (GAC) filter (e.g., a bed or column).

In some embodiments, the first stream outlet is configured to retain from about 75% to about 100% (e.g., from about 75% to no greater than 100%, or from about 75% to about 99%) (by volume) of the wet extraction agent phase in the first stream channel while permitting the portion of the raffinate phase to exit the first stream channel. For example, the first stream outlet may permit of from about 60% to about 100% (by volume) of the raffinate phase to exit the first stream channel. In other embodiments, the first stream outlet is configured to retain from about 80% to about 99% (by volume) of the wet extraction agent phase in the first stream channel while permitting from about 80% to about 100% (by volume) of the raffinate phase to exit the first stream channel.

In some embodiments, the balancer comprises a first stream actuator 26 in fluid communication with an upstream portion of the first feed stream. When present, the first stream actuator provides the extraction agent, the aqueous solution, or both to the first stream channel. In some embodiments, the first stream actuator is a pump. The pump may be, by way of non-limiting example, a rotary-type positive displacement pump (such as a gear pump or a screw pump), a reciprocating-type positive displacement pump (such as a plunger pump, a diaphragm pump or a piston pump), a linear-type positive displacement pump (such as a rope pump or a chain pump), an impulse pump (such as a hydraulic ram pump, a pulser pump or an airlift pump), a velocity pump, a radial-flow pump, an axial-flow pump, or a gravity pump.

As shown in FIG. 1, the first heater fluidly communicates with the first stream channel and thermally communicates with the reduced first feed stream. The first heater is configured to heat at least a portion of the reduced first feed stream to a temperature of from about 35° C. to about 130° C. (e.g., from about 40° C. to about 110° C., from about 45° C. to about 90° C., from about 50° C. to about 85° C., from about 60° C. to about 80° C., or from about 70° C. to about 90° C.) to form a heated extraction agent phase and a heated aqueous solution phase. In some embodiments, the first heater comprises one or more heating elements.

The heated extraction agent phase has reduced water content as compared to the wet extraction agent phase. In some embodiments, the heated extraction agent phase has a density that is less than the density of the heated aqueous solution phase. The heated aqueous solution phase has a concentration of sodium chloride that is less than the aqueous solution.

The first heater comprises a first heater outlet 28 configured to permit a portion of the heated extraction agent phase to exit the first heater to give a heated balanced mixture including a volume ratio of heated extraction agent phase to heated aqueous solution phase of from about 5:1 to about 1:10 (e.g., from about 5:1 to about 1:5, from about 3:1 to about 1:3, from about 2:1 to about 1:2, or about 1:1).

In some embodiments, the first heater outlet is configured to permit the portion of heated extraction agent phase to exit the first heater substantially free of heated raffinate phase. For example, the portion of heated extraction agent phase exiting the first heater comprises from about 0% to about 25% by volume of the heated raffinate phase. In other embodiments, the portion of heated extraction agent phase exiting the first heater comprises from about 0% to about 10% by volume of the heated raffinate phase. And, in some embodiments, the first heater outlet is configured to permit the portion of heated extraction agent phase to exit the first heater free of the heated raffinate phase.

In some embodiments, the first heater further comprises a rate meter 30. When present, the rate meter 30 cooperates with the first heater outlet 28 to modulate the flow of the heated extraction agent phase and heated raffinate phase to form the balanced mixture.

### B. Second Feed Stream

With continued reference to FIG. 1, the second feed stream comprises a second stream channel 32 and a second stream outlet 34. The second stream channel 32 fluidly communicates with the first heater and is configured to permit the heated balanced mixture to cool and form a volume-adjusted wet extraction agent phase and a cooled aqueous solution phase. For example, the second stream channel may comprise a cooling device (not shown). In other embodiments, the second stream channel may permit the heated balance mixture to cool due to an absence of heating.

The cooled aqueous solution phase has a concentration of sodium chloride that is greater than the heated aqueous solution phase. The volume-adjusted wet extraction agent phase has increased water content as compared to the heated extraction agent phase. In some embodiments, the volume-adjusted wet extraction agent phase has a density that is less than the density of the cooled aqueous solution phase.

In some embodiments, the second stream channel is configured to mix the heated balanced mixture after cooling for a period of from about 1 second to about 5 minutes (e.g., from about 3 seconds to about 5 minutes, from about 30 seconds to about 2 minutes, from about 30 seconds to about 1.5 minutes, from about 10 seconds to about 30 seconds, from about 5 seconds to about 2 minutes, from about 5 seconds to about 1.5 minutes, or about 1 minute).

The second stream outlet is configured to permit at least a portion of the cooled aqueous solution phase to exit the second stream channel and form a concentrated wet extraction agent mixture. The concentrated wet extraction agent mixture has a volume ratio of volume-adjusted wet extraction agent phase to cooled aqueous solution phase that is greater than the second stream feed due to the removal of the portion of the cooled aqueous solution phase from the second stream channel.

In some embodiments, as shown in FIG. 1, the second stream outlet is configured to permit the portion of the cooled aqueous solution phase exiting the second stream channel to be released into the environment. In some embodiments, the second stream outlet comprises a valve 36 fluidly coupled to the second stream channel. The valve may be any valve suitable for permitting a portion of the cooled aqueous solution phase to exit the second stream channel.

With continued reference to FIG. 1, in some embodiments, the balancer further comprises a second sparging tank 37. When present, the second sparging tank 37 is in fluid communication with the second stream outlet and is configured to sparge at least a portion of the cooled aqueous solution phase to remove extraction agent from the cooled aqueous solution phase. In this manner, the cooled aqueous solution phase can be released into the environment substantially free or free of the extraction agent. In some embodiments, in addition to or in place of the second sparging tank, the balancer comprises a GAC filter (e.g., a bed or column).

In some embodiments, the second stream outlet is configured to retain from about 75% to about 99% (by volume) of the volume-adjusted wet extraction agent phase in the second stream channel while permitting the portion of the cooled aqueous solution phase to exit the second stream channel. For example, the second stream outlet may permit of from about 60% to about 100% (by volume) of the cooled aqueous solution phase to exit the first stream channel. In other embodiments, the second stream outlet is configured to retain from about 80% to about 99% (by volume) of the volume-adjusted wet extraction agent phase in the second stream channel while permitting from about 80% to about 100% (by volume) of the cooled aqueous solution phase to exit the second stream channel 32.

### C. Extractor

With continue reference to FIG. 1, the extractor fluidly communicates with the second stream channel. The extractor comprises an extractor heater 38 and a water outlet 40. The extractor heater is configured to heat at least a portion of the concentrated wet extraction agent mixture to a temperature of from about 35° C. to about 130° C. (e.g., from about 40° C. to about 110° C., from about 45° C. to about 90° C., from about 50° C. to about 85° C., or from about 60° C. to about 80° C.) to form a dry extraction agent phase and a water phase. The dry extraction agent phase has a reduced water content as compared to the volume-adjusted wet extraction agent phase. In some embodiments, the dry extraction agent phase has a density that is less than the density of the water phase.

The water outlet is configured to permit at least a portion of the water phase exit the extractor. In some embodiments, the water outlet comprises a valve (not shown) fluidly coupled to the extractor. The valve may be any valve suitable for permitting at least a portion of the water phase to exit the extractor. The water phase has a concentration of sodium chloride that is less than the concentration of sodium chloride in the aqueous solution. In some embodiments, the water phase has a concentration of sodium chloride that is from about 65% to about 99% less than the concentration of sodium chloride in the aqueous solution. In other embodiments, the water phase has a concentration of sodium chloride that is from about 70% to about 99% less than the concentration of sodium chloride in the aqueous solution. In some embodiments, the water phase has a concentration of sodium chloride that is from about 65% to about 95% less than the concentration of sodium chloride in the aqueous solution. And, in some embodiments, the water phase has a concentration of sodium chloride that is from about 65% to about 90% less than the concentration of sodium chloride in the aqueous solution.

In some embodiments, the water phase comprises a concentration of sodium chloride of less than about 1,500 mg/L. In some embodiments, the water phase comprises a concentration of sodium chloride of less than about 1,250 mg/L. In some embodiments, the water phase comprises a concentration of sodium chloride of less than about 1,000 mg/L. In other embodiments, the water phase comprises a concentration of sodium chloride of less than about 750 mg/L. In some embodiments, the water phase comprises a concentration of sodium chloride of less than about 500 mg/L. And, in some embodiments, the water phase comprises a concentration of sodium chloride of less than about 250 mg/L.

In some embodiments, the water phase has a concentration of total dissolved solids (TDS) of less than 15,000 mg/L. For example, the water phase has a concentration of TDS of less than 10,000 mg/L. In other embodiments, the water phase has a concentration of TDS of less than 7,500 mg/L. In some embodiments, the water phase has a concentration of TDS of less than 5,000 mg/L. In some embodiments, the water phase has a concentration of TDS of less than 2,500 mg/L. In some embodiments, the water phase has a concentration of TDS of less than 1,000 mg/L. In some embodiments, the water phase has a concentration of TDS of less than 800 mg/L. In some embodiments, the water phase has a concentration of TDS of less than 500 mg/L. In some embodiments, the water phase has a concentration of TDS of less than 250 mg/L. And, in some embodiments, the water phase has a concentration of TDS that is less than the concentration of TDS in the aqueous solution.

In some embodiments, the water phase is potable. In other embodiments, the water phase is suitable for agricultural use.

In some embodiments, the water phase is substantially free of the extraction agent. For example, the water phase may comprise from about 0% to about 25% (e.g., from about 0.01% to about 15%, from about 0.05% to about 10%, from about 0.1% to about 8.5%, or from about 0.1% to about 5%) by volume of the extraction agent. And, in some embodiments, the water phase has no detectable amount of extraction agent.

In some embodiments, the balancer further comprises a recycling conduit 42 in fluid communication with the first heater outlet and the first feed stream. When present, the recycling conduit is configured to permit a portion of the heated extraction agent phase to exit the first heater and return to the first feed stream as extraction agent. In this manner, the balancer allows for recycling of the extraction agent thereby reducing costs associated with the extraction process.

In some embodiments, the extractor comprises an extraction agent outlet 44. When present, the extraction agent outlet 44 comprises a valve 46 configured to permit from about 50% to about 100% (e.g., from about 50% to no greater than 100%, from about 75% to about 100%, or from about 75% to no greater than 100%) by volume of the dry extraction agent to exit the extractor.

In some embodiments, the balancer further comprises a second recycling conduit 48 in fluid communication with the extraction agent outlet. The second recycling conduit is configured to return the dry extraction agent exiting the extractor to the first feed stream as extraction agent. In this manner, the balancer allows for recycling of the extraction agent thereby reducing costs associated with the extraction process.

In some embodiments, the balancer further comprises at least one solar cell 50 configured to power the first heater, the extractor heater, the first stream actuator, or any combination thereof.

In some embodiments, the balancer further comprises a sparger 52 (e.g., a third sparging tank) in fluid communication with the water outlet. The sparger is configured to vaporize extraction agent from the water phase. In this manner, the sparger ensures that the water phase is substantially free or free of the extraction agent as described herein.

The aqueous solution comprises a concentration of sodium chloride. In some embodiments, the aqueous solution comprises a concentration of sodium chloride of from about 300 mg/L to about 45,000 mg/L. For example, the aqueous solution comprises a concentration of sodium chloride of from about 30,000 mg/L to about 40,000 mg/L. In other embodiments, the aqueous solution has a sodium chloride concentration of from about 500 mg/L to about 30,000 mg/L. In some embodiments, the aqueous solution has a concentration of sodium chloride of greater than about 45,000 mg/L. In some embodiments, the aqueous solution has a concentration of sodium chloride of from about 350 mg/L to about 40,000 mg/L. In some embodiments, the aqueous solution has a concentration of sodium chloride of less than about 1,000 mg/L. In some embodiments, the aqueous solution has a concentration of sodium chloride of less than about 500 mg/L. In some embodiments, the aqueous solution has a concentration of sodium chloride of less than about 250 mg/L. In some embodiments, the aqueous solution has a concentration of sodium chloride of less than about 100 mg/L. The aqueous solution may comprise, by way of non-limiting example, seawater; well water; brackish water; briny water; or any combination thereof. For example, the aqueous solution may be seawater or well water.

In some implementations, the aqueous solution has a concentration of sodium chloride of greater than about 8,500 mg/L. For example, the aqueous solution may have a concentration of sodium chloride of 10,000 mg/L to about 50,000 mg/L. In some implementations, the aqueous solution has a concentration of sodium chloride of 15,000 mg/L to about 45,000 mg/L. In some implementations, the aqueous solution has a concentration of sodium chloride of 20,000 mg/L to about 40,000 mg/L. In some implementations, the aqueous solution has a concentration of sodium chloride of from about 27,000 mg/L to about 37,000 mg/L.

In some embodiments, the aqueous solution has a concentration of total dissolved solids (TDS) of from about 250 mg/L to about 50,000 mg/L. In some embodiments, the aqueous solution has a concentration of TDS of from about 250 mg/L to about 10,000 mg/L. In other embodiments, the aqueous solution has a concentration of TDS of from about 1,000 mg/L to about 10,000 mg/L.

In some embodiments, the extraction agent has a density and the aqueous solution has a density, and the density of the extraction agent is less than the density of the aqueous solution. In other embodiments, the extraction agent has a density and the aqueous solution has a density, and the density of the extraction agent is greater than the density of the aqueous solution.

The extraction agent may comprise any extraction agent that is substantially immiscible with aqueous solutions, capable of water absorption at a first temperature (e.g., about ambient temperature), and exhibits decreased water solubility at a second temperature (e.g., about 35° C. to about 130° C.) that is higher than the first temperature. For example, in some embodiments, the extraction agent comprises a tertiary or secondary amine having the formula N(R¹)₃, wherein each R¹ is independently hydrogen, an optionally substituted straight or branched C₁₋₂₀ alkyl (e.g., C₁₋₁₂ alkyl, C₂₋₁₂ alkyl, C₁₋₁₀ alkyl, C₂₋₁₀ alkyl, C₁₋₆ alkyl, C₂₋₆ alkyl, or C₁₋₃ alkyl), an optionally substituted C₃₋₁₄ mono- or bicyclic cycloalkyl (e.g., a C₃₋₈ monocyclic cycloalkyl (e.g., a C₃₋₆ monocyclic cycloalkyl) or a C₆₋₁₂ bicyclic cycloalkyl (e.g., a C₆₋₁₀ bicyclic cycloalkyl)), or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

In some embodiments, the extraction agent comprises a di-amine having the formula (R¹)₂N-L-N(R¹)₂ wherein L is a C₁₋₁₄ (e.g., C₁₋₁₀, C₂₋₁₀, C₁₋₈, C₂₋₈, C₁₋₆, or C₂₋₆) bivalent, straight or branched alkylene chain, and each R¹ is independently hydrogen, an optionally substituted straight or branched C₁₋₂₀ alkyl (e.g., C₁₋₁₂ alkyl, C₂₋₁₂ alkyl, C₁₋₁₀ alkyl, C₂₋₁₀ alkyl, C₁₋₆ alkyl, C₂₋₆ alkyl, or C₁₋₃ alkyl), an optionally substituted C₃₋₁₄ mono- or bicyclic cycloalkyl (e.g., a C₃₋₈ monocyclic cycloalkyl (e.g., a C₃₋₆ monocyclic cycloalkyl) or a C₆₋₁₂ bicyclic cycloalkyl (e.g., a C₆₋₁₀ bicyclic cycloalkyl)), or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

In some embodiments, the extraction agent comprises a silamine having the formula (R²)ₙSi(NHR¹)₄₋ₙ wherein
n is 1, 2, or 3;
each R¹ is independently hydrogen, a straight or branched C₁₋₁₀ alkyl, an optionally substituted C₁₋₁₀ mono- or bicyclic cycloalkyl, or an optionally substituted C₆₋₁₀ mono- or bicyclic aryl, wherein the cycloalkyl and aryl of R¹ are each optionally substituted with up to two C₁₋₄ alkyl groups; and
each R² is independently hydrogen, a straight or branched C₁₋₁₀ alkyl, an optionally substituted straight or branched C₁₋₁₀ alkoxy, an optionally substituted C₁₋₁₀ mono- or bicyclic cycloalkyl, or an optionally substituted C₆₋₁₀ mono- or bicyclic aryl, wherein the cycloalkyl and aryl of R² are each optionally substituted with up to two C₁₋₄ alkyl groups, and the alkoxy of R² is optionally substituted with up to three groups independently selected from halo, phenyl, C₁₋₆ monocyclic cycloalkyl, and C₂₋₄ alkenyl.

And, in some embodiments, the extraction agent comprises any combination of an amine, di-amine, and/or silamine such as any of those described herein.

In some embodiments, the extraction agent comprises methylamine; ethylamine; propylamine; isopropylamine; butylamine; sec-butylamine; iso-butylamine; tert-butylamine; amylamine; hexylamine; heptylamine; 1-methylhexylamine; octylamine; 1-ethylpentylamine; 2-ethylhexylamine; 2-ethylbutylamine; 2-ethyl-1-hexylamine; tert-octylamine; nonylamine; decylamine; dodecylamine; hexadecylamine; octadecylamine; dimethylamine; diethylamine; dipropylamine; di-iso-propylamine; dibutylamine; di-sec-butylamine; di-iso-butylamine; di-tert-butylamine; diisobutylamine; N,N-ethylcyclohexylamine; N-methylcyclohexylamine; N-methyl-tert-butylamine; N-methyl-iso-butylamine; N-methylpentylamine; di-allylamine; N-ethylmethylamine; N-iso-propylmethylamine; N-methylbutylamine; N-methyl-n-amylamine; N-ethyl-tert-butylamine; N-ethyl-sec-butylamine; N-ethylpropylamine; N-ethyl-iso-propylamine; N-ethyl-n-butylamine; dioctylamine; N-methyldodecylamine; propylbutylamine; N-ethylbenzylamine; 1,3-dimethylbutylamine; N,N-dimethyl-iso-propylamine; dimethylpropylamine; N,N-dimethyl-iso-butylamine; N,N-dimethyl-tert-butylamine; N,N-dimethylcyclohexylamine; N,N-dimethylethylamine; N,N-diethylmethylamine; triethylamine; di-iso-propylmethylamine; 2-(isopropylamino) ethanol; tripropylamine; trioctylamine; N,N-dimethylhexadecylamine; 1,8-diaminooctane; 1,12-diaminododecane; 1,3-dimethylamylamine; 2-aminopentane; N,N,5,5-tetramethyl-1,3-dioxan-2amine; bis[3-trimethoxysilyl)propyl]amine; octanoic acid; decanoic acid; hexanoic acid; tri-8-chlorooctylamine; trioctylamine; trioctadecylamine; or any combination thereof. And, in some embodiments, the extraction agent comprises dipropylamine; di-iso-propylamine; or any combination thereof.

In some embodiments, the extraction agent comprises a tertiary or secondary amine having a molecular weight of greater than about 200 g/mol. In some embodiments, the extraction agent comprises a tertiary or secondary amine having a molecular weight of greater than about 300 g/mol. In some embodiments, the extraction agent comprises a tertiary or secondary amine having a molecular weight of greater than about 400 g/mol. In other embodiments, the extraction agent comprises a tertiary or secondary amine having a molecular weight of greater than about 600 g/mol. In some embodiments, the extraction agent comprises a tertiary or secondary amine having a molecular weight of from about 200 g/mol to about 1,000 g/mol. In some embodiments, the extraction agent comprises a tertiary or secondary amine having a molecular weight of from about 300 g/mol to about 1,000 g/mol. And, in some embodiments, the extraction agent comprises a tertiary or secondary amine having a molecular weight of from about 400 g/mol to about 1,000 g/mol.

In some embodiments, the extraction agent may comprise an inorganic or organic acid addition salt of any the amines, di-amines, and/or silamines described herein. For example, the extraction agent may comprise an HCl salt of any of the amines, di-amines, and/or silamines described herein. In other embodiments, the extraction agent may comprise an octanoic acid salt of any of the amines, di-amines, and/or silamines described herein. And, in some embodiments, the extraction agent may comprise a fatty acid salt of any of the amines, di-amines, and/or silamines described herein.

In some embodiments, the extraction agent comprises a co-solvent. The co-solvent may comprise, by way of non-limiting example, methyl tert-butyl ether (MTBE); acetone; ammonia; methylethylketone; ethylene glycol; propylene glycol; methanol; ethanol; propanol; butanol; pentanol; hexanol; heptanol; octanol; nonanol; decanol; ethyl acetate; cyclopentanone; cyclohexanone; 2-ethyl-3-methylcyclopentan-1-one; 1,4-cyclohexanedione; 1,2-cyclohexanedione; ethyl methyl sulfone; butyl sulfone; dimethyl sulfone; benzyl sulfone; ethyl phenyl sulfone; 1-ethoxy-3-propoxy-2-propanol; 1-butoxy-3-methoxy-2-propanol; 1-propopxy-2-propanol; diethylene glycol-mono-n-butyl ether; tripropylene glycol-mono-butyl ether; di(propylene glycol)propyl ether; tri(propylene glycol)propyl ether; 4-butylmorpholine; 2,4-dimethyl-1,3-dioxane; or any combination thereof.

Without wishing to be bound by theory, it is believed that formation of the balanced mixture, cooling of the balanced mixture, and subsequent heating of the concentrated wet extraction agent mixture improves the efficiency of water extraction from the aqueous solution in the balancer. Additionally, the heating and/or mixing cycles associated with the balancer are relatively mild and require less electricity than conventional systems for extracting water from aqueous solutions. Moreover, recycling the extraction agent further reduces the costs associated with the extraction process. Accordingly, the balancer provides efficient, and cost effective, access to water from aqueous solutions.

In another embodiment, the balancer (not shown) comprises a reservoir configured to hold an extraction agent phase (e.g., a heated extraction agent phase) and an aqueous solution phase (e.g., a heated aqueous solution phase); a balancer outlet configured to permit at least a portion of the extraction agent phase to exit the reservoir (e.g., while retaining all or substantially all of the aqueous phase in the reservoir) to generate a balanced mixture having a volume ratio of extraction agent phase to aqueous solution phase of from about 5:1 to about 1:10 (e.g., from about 3:1 to about 1:3); and a heater configured to thermally communicate with the extraction agent phase and the aqueous solution phase held by the reservoir.

In some embodiments, the reservoir fluidly communicates with an extraction agent recycling loop via the balancer outlet, wherein extraction agent exiting the reservoir from the balancer outlet is recycled as wet or dry extraction agent for use in one or more upstream processes (e.g., the extraction agent is mixed with aqueous solution to form the wet extraction agent phase or the like). In some embodiments, the reservoir further comprises an aqueous phase outlet configured to permit at least a portion (e.g., all or substantially all) of the aqueous phase (e.g. cooled aqueous phase) to exit the reservoir (e.g., while retaining all or substantially all of the extraction phase in the reservoir). In some embodiments, the aqueous phase outlet is also configured to permit the water phase to exit the reservoir.

### III. System for Extracting Water from an Aqueous Solution

In another aspect, provided herein is a system for extracting water from an aqueous solution.

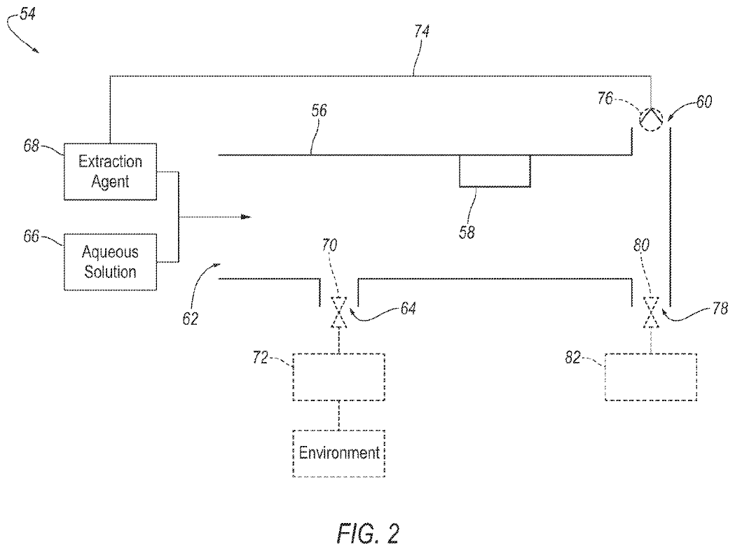

Referring to FIG. 2, in one embodiment, the system 54 for extracting water from an aqueous solution comprises a reservoir 56, a heater 58, and an upper outlet 60.

The reservoir comprises an inlet 62 and a lower outlet 64. The inlet is configured to provide a feed stream comprising an extraction agent and an aqueous solution to the reservoir under mixing conditions, at about ambient temperature (i.e., without heating or cooling the feed stream), to form a wet extraction agent phase and a raffinate phase.

The aqueous solution and the extraction agent can be mixed or combined upstream of the inlet, at the inlet, or both, using any suitable method(s) known in the art. In some embodiments, the aqueous solution is withdrawn (e.g., pumped) from an aqueous solution source 66 and combined (or mixed) with the extraction agent withdrawn from an extraction agent source 68, to form the feed stream upstream of or at the inlet of the reservoir.

In some embodiments, the feed stream provided to the reservoir via the inlet may optionally undergo additional mixing within the reservoir. For example, in some embodiments, the reservoir comprises an optional mixer (e.g., rotor or shaker) configured to mix the aqueous solution and extraction agent forming the feed stream. The feed stream provided to the reservoir forms a wet extraction phase and a raffinate phase within the reservoir, wherein the raffinate phase has a reduced water content and an increased concentration of sodium chloride as compared to the aqueous solution at the aqueous solution source due to water absorption by the extraction agent during mixing. In some embodiments, the raffinate phase has a greater density than the wet extraction agent phase during operating conditions (e.g., operating temperatures and pressures) of the system.

With continued reference to FIG. 2, the lower outlet is reversibly closable and is configured to permit at least a portion (e.g., from about 50% to 100% by volume, from about 70% to 100% by volume, from about 80% to 100% by volume, from about 85% to 100% by volume, from about 90% to 100% by volume, from about 95% to 100% by volume, or from about 99% to 100% by volume) of the raffinate phase to exit the reservoir while retaining from all or nearly all (e.g., from about 50% to 100% by volume, from about 60% to 100% by volume, from about 80% to 100% by volume, from about 90% to 100% by volume, or from about 95% to 100% by volume) of the wet extraction agent phase in the reservoir.

In some embodiments, the lower outlet comprises a reversibly closable valve 70 as shown in FIG. 1. In some embodiments, the reversibly closable valve of the lower outlet comprises a solenoid configured to open the reversibly closable valve when power is supplied to the solenoid and close when power is not supplied to the solenoid. In other embodiments, the reversibly closable valve comprises a spring-operated cap, wherein the spring-operated cap is configured to assume an open position when pressure inside the reservoir reaches a threshold.

In some embodiments, the lower outlet is spatially oriented on the reservoir so that the lower outlet is below the upper outlet, as shown in FIG. 2.

In some embodiments, as shown in FIG. 2, the system further comprises a sparging tank 72 in fluid communication with the lower outlet. When present, the sparging tank is configured to sparge at least a portion of the raffinate phase to remove at least a portion of any extraction agent present in the raffinate phase. In this manner, the raffinate phase can be released into the environment (e.g., returned to the aqueous solution source) substantially free or free, of the extraction agent. In some embodiments, in addition to or in place of the sparging tank, the balancer comprises a granular activated carbon (GAC) filter (e.g., a bed or column).

The heater is configured to thermally communicate with the wet extraction phase and heat the wet extraction agent phase to a temperature of from about 35° C. to about 130° C. (e.g., from about 40° C. to about 110° C., from about 45° C. to about 90° C., from about 50° C. to about 85° C., or from about 60° C. to about 80° C.) to form a heated mixture comprising a dry extraction agent phase and a water phase. In some embodiments, the heater is situated within the reservoir and thermally communicates with the wet extraction agent phase. In other embodiments, the reservoir comprises a thermally conductive wall (not shown), and the heater thermally communicates with the wet extraction agent through the thermally conductive wall of the reservoir. In some embodiments, the heater comprises one or more heating elements.

The dry extraction agent phase has reduced water content compared to the wet extraction agent phase. While not being bound by theory, it is believed that heating the wet extraction agent phase decreases the water solubility of the extraction agent and causes dissolved water to desorb from the wet extraction agent phase to form the dry extraction phase and the water phase. In some embodiments, the dry extraction agent phase has a density less than the density of the water phase during operating conditions (e.g., operating temperatures and pressures) of the system.

The upper outlet fluidly communicates with a channel 74, wherein the channel is configured to permit at least a portion of the dry extraction agent phase to return to the feed stream as extraction agent. In this manner, the system allows for recycling of the extraction agent thereby reducing costs associated with the extraction process. In some embodiments, such as the embodiment shown in FIG. 2, the channel fluidly communicates with the extraction agent source, and the dry extraction agent phase flows to the extraction agent source before proceeding to the feed stream. In other embodiments, the channel does not fluidly communicate with the extraction agent source. For example, the channel fluidly communicates with a portion of the system upstream from or at the inlet. For instance, the channel may fluidly communicate with the inlet so that the dry extraction agent phase is incorporated into the feed stream at the inlet of the reservoir.

In some embodiments, the system further comprises a pump 76 that fluidly communicates with the upper outlet and the channel. In some embodiments, the pump is configured to move at least a portion of the dry extraction agent phase from the reservoir into the channel. The pump may be, by way of non-limiting example, a rotary-type positive displacement pump (such as a gear pump or a screw pump), a reciprocating-type positive displacement pump (such as a plunger pump, a diaphragm pump or a piston pump), a linear-type positive displacement pump (such as a rope pump or a chain pump), an impulse pump (such as a hydraulic ram pump, a pulser pump or an airlift pump), a velocity pump, a radial-flow pump, an axial-flow pump, or a gravity pump.

In some embodiments, the reservoir further comprises an optional second lower outlet 78. When present, the second lower outlet is configured to permit at least a portion of the water phase to exit the reservoir. In some embodiments, the second lower outlet is reversibly closable. For example, the second lower outlet comprises a second reversibly closable valve 80. The second reversibly closable valve may be any valve as described herein.

In some embodiments, the second lower outlet fluidly communicates with a tank. For example, the second lower outlet fluidly communicates with a second sparging tank 82. When present, the second sparging tank is configured to sparge at least a portion of the water phase to remove at least a portion of any extraction agent from the water phase. In other embodiments, the second lower outlet fluidly communicates with a tank that comprises a filtration (e.g., osmotic filter, GAC filter, and the like) device or distillation device or both, wherein the filtration device and/or the distillation device are configured to separate substantially pure water from the water phase. In these manners, water from the water phase can be recovered substantially free (e.g., comprising less than 1% by volume, comprising less than 0.5% by volume, or comprising less than 0.1% by volume) or free of the extraction agent and/or other impurities. And, in some embodiments, the water phase has no detectable amount of extraction agent.

In some embodiments, the second lower outlet is spatially oriented on the reservoir so that the second lower outlet is below the upper outlet, as shown in FIG. 2.

In some embodiments, the second lower outlet fluidly communicates with the extraction agent source via a second channel (not shown) configured to permit at least a portion of the water phase to combine or mix with extraction agent. In some embodiments the second lower outlet fluidly communicates with the channel and is configured to mix at least a portion of the dry extraction agent phase (i.e., the recycled dry extraction agent phase) with at least a portion of the water phase to form a second feed stream comprising extraction agent and the water phase, wherein the second feed stream is provided to the reservoir at the inlet. In these manners, the system allows for the water phase to be cycled two or more times through the reservoir to further reduce the concentration of sodium chloride in the water phase. The second channel may also be configured to permit the temperature of the water phase to cool before returning to the feed stream. When the water phase is recycled through the reservoir two or more times, the second reversibly closable valve is configured to allow the water phase to be recycled to the to the inlet of the reservoir or to exit the system.

In some embodiments, two systems may be arranged or configured in series (not shown) and the water phase exiting through the second lower outlet of one system may be the aqueous solution source of the other system. When two systems are arranged in series, a transition channel may be in fluid communication with the second lower outlet of one system and the inlet of the other system and configured to permit flow of the water phase from the second lower outlet of one system to the inlet of the other system. In this manner, the concentration of sodium chloride of the water phase can be further reduced. The transition channel may also be configured to permit the temperature of the water phase to cool before entering the inlet of the other system.

The aqueous solution may be any aqueous solution as described herein. The aqueous solution may have any concentration of sodium chloride as described herein. The aqueous solution may have any concentration of TDS as described herein.

The extraction agent may include any extraction agent as described herein. In some embodiments, the extraction agent comprises a co-solvent as described herein.

The water phase has a concentration of sodium chloride that is less than the concentration of sodium chloride in the aqueous solution. The water phase may have any concentration of sodium chloride as described herein. The water phase may be free, or substantially free, of the extraction agent as described herein. The water phase may have any concentration of TDS as described herein.

In some embodiments, the system further comprises one or more solar cells configured to provide electricity and/or heat for operation of the system.

### IV. Method for Extracting Water from an Aqueous Solution

In another aspect, provided herein are methods of extracting water from an aqueous solution. In some implementations, the aqueous solution has a relatively high concentration of sodium chloride dissolved therein. For example, the aqueous solution has a concentration of sodium chloride of greater than about 8,500 mg/L (e.g., from about 10,000 mg/L to about 50,000 mg/L, from about 15,000 mg/L to about 45,000 mg/L, from about 20,000 mg/L to about 40,000 mg/L, or from about 27,000 mg/L to about 37,000 mg/L).

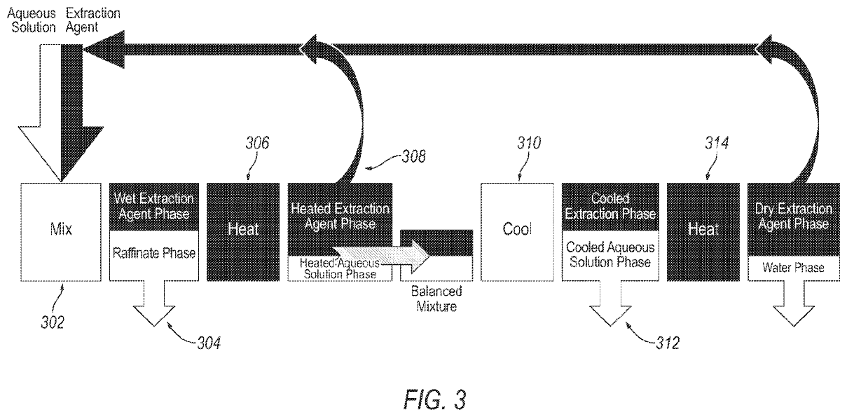

With reference to FIG. 3, a flow chart depicting an exemplary implementation of a method of extracting water from an aqueous solution is provided. The method comprises:
(a-1) mixing an extraction agent and the aqueous solution at about ambient temperature to form a first feed mixture including a wet extraction agent phase and a raffinate phase (302), wherein the aqueous solution comprises a concentration of sodium chloride;
(b-1) removing at least a portion of the raffinate phase from the first feed mixture (304);
(c-1) heating the wet extraction agent phase to a temperature of from about 35° C. to about 130° C. to form a second feed mixture including a heated extraction agent phase and a heated aqueous solution phase (306);
(d-1) reducing the volume of the second feed mixture to provide a balanced mixture having a volume ratio of from about 5:1 to about 1:10 of heated extraction agent phase to heated aqueous solution phase (308);
(e-1) reducing the temperature of the balanced mixture by at least 15° C. to form a cooled mixture including a cooled extraction agent phase and a cooled aqueous solution phase (310);
(f-1) removing at least a portion of the cooled aqueous solution phase from the cooled mixture to form a concentrated extraction agent mixture (312); and
(g-1) heating the concentrated extraction agent mixture to a temperature of from about 35° C. to about 130° C. to form a dry extraction agent phase and a water phase, wherein the water phase comprises a concentration of sodium chloride that is less than the concentration of sodium chloride in the aqueous solution (314).

In some implementations, step (a-1) comprises mixing a volume ratio of from about 5:1 to about 1:5 of extraction agent to aqueous solution. In other implementations, step (a-1) comprises mixing a volume ratio of from about 3:1 to about 1:3 of extraction agent to aqueous solution. In some implementations, step (a-1) comprises mixing a volume ratio of from about 2:1 to about 1:2 of extraction agent to aqueous solution. For example, step (a-1) comprises mixing a volume ratio of from about 1.5:1 to about 1:1.5 of extraction agent to aqueous solution. And, in some implementations, step (a-1) comprises mixing a volume ratio of about 1:1 of extraction agent to aqueous solution.

In some implementations, step (a-1) comprises mixing the extraction agent and the aqueous solution for a period of from about 1 second to about 5 minutes (e.g., from about 3 seconds to about 5 minutes, from about 30 seconds to about 3 minutes, from about 30 seconds to about 2 minutes, from about 30 seconds to about 1.5 minutes, from about 10 seconds to about 30 seconds, from about 5 seconds to about 2 minutes, from about 5 seconds to about 1.5 minutes, or about 1 minute).

In some implementations, the extraction agent has a density and the aqueous solution has a density, and the density of the extraction agent is less than the density of the aqueous solution. In other implementations, the extraction agent has a density and the aqueous solution has a density, and the density of the extraction agent is greater than the density of the aqueous solution.

The extraction agent may comprise any extraction agent as described herein. In some implementations, the extraction agent comprises a co-solvent as described herein.

The aqueous solution may be any aqueous solution as described herein. For example, the aqueous solution may be sea water or well water. The aqueous solution may have any concentration of sodium chloride as described herein. For example, the aqueous solution may comprise a concentration of sodium chloride of from about 350 mg/L to about 40,000 mg/L.

In some implementations, the aqueous solution has a concentration of sodium chloride of greater than about 8,500 mg/L. For example, the aqueous solution may have a concentration of sodium chloride of 10,000 mg/L to about 50,000 mg/L. In some implementations, the aqueous solution has a concentration of sodium chloride of 15,000 mg/L to about 45,000 mg/L. In some implementations, the aqueous solution has a concentration of sodium chloride of 20,000 mg/L to about 40,000 mg/L. In some implementations, the aqueous solution has a concentration of sodium chloride of from about 27,000 mg/L to about 37,000 mg/L.

In some implementations, step (b-1) comprises removing from about 50% to about 100% by volume of the raffinate phase from the first feed mixture. For example, step (b-1) may comprise removing from about 80% to about 100% by volume of the raffinate phase from the first feed mixture. In other implementations, step (b-1) comprises removing from about 70% to about 100% by volume of the raffinate phase from the first feed mixture. And, in some implementations, step (b-1) comprises removing about 100% by volume of the raffinate phase from the first feed mixture.

In some implementations, step (c-1) comprises heating the wet extraction agent phase to a temperature of from about 40° C. to about 110° C. (e.g., from about 45° C. to about 90° C., from about 50° C. to about 85° C., from about 60° C. to about 80° C., or from about 70° C. to about 90° C.).

In some implementations, step (d-1) comprises reducing the volume of the second feed mixture to provide a balanced mixture having a volume ratio of from about 5:1 to about 1:5 of heated extraction agent phase to heated aqueous solution phase. For example, step (d-1) may comprise reducing the volume of the second feed mixture to provide a balanced mixture having a volume ratio of from about 3:1 to about 1:3 of heated extraction agent phase to heated aqueous solution phase. In some implementations, step (d-1) comprises reducing the volume of the second feed mixture to provide a balanced mixture having a volume ratio of from about 2:1 to about 1:2 of heated extraction agent phase to heated aqueous solution phase. And, in some implementations, step (d-1) comprises reducing the volume of the second feed mixture to provide a balanced mixture having a volume ratio of about 1:1.

In some implementations, as shown in FIG. 3, step (d-1) comprises removing a portion of the heated extraction agent phase from the second mixture to provide a balanced mixture having a volume ratio of from about 5:1 to about 1:10 of heated extraction agent phase to heated aqueous solution phase. In such implementations, the portion of the heated extraction agent phase removed from the second mixture may be recycled in any additional instances of step (a-1). The heated extraction agent phase may be cooled before being recycled in any additional instances of step (a-1).

In some implementations, step (d-1) comprises removing the portion of the heated extraction agent phase from the second feed mixture to provide a balanced mixture having a volume ratio of from about 5:1 to about 1:5 of heated extraction agent phase to heated aqueous solution phase. For example, step (d-1) may comprise removing the portion of the heated extraction agent phase from the second feed mixture to provide a balanced mixture having a volume ratio of from about 3:1 to about 1:3 of heated extraction agent phase to heated aqueous solution phase. In some implementations, step (d-1) comprises removing the portion of the heated extraction agent phase from the second feed mixture to provide a balanced mixture having a volume ratio of from about 2:1 to about 1:2 of heated extraction agent phase to heated aqueous solution phase. And, in some implementations, step (d-1) comprises removing the portion of the heated extraction agent phase from the second feed mixture to provide a balanced mixture having a volume ratio of about 1:1.

In some implementations, step (d-1) comprises removing a portion of the heated aqueous solution phase from the second mixture to provide a balanced mixture having a volume ratio of from about 5:1 to about 1:10 of heated extraction agent phase to heated aqueous solution phase. In such implementations, the portion of the heated aqueous solution phase removed from the second mixture may be recycled in any additional instances of step (a-1) to reduce the concentration of sodium chloride of the aqueous solution. The heated aqueous solution phase may be cooled before being recycled in any additional instances of step (a-1).

In some implementations, step (d-1) comprises removing the portion of the heated aqueous solution phase from the second mixture to provide a balanced mixture having a volume ratio of from about 5:1 to about 1:5 of heated extraction agent phase to heated aqueous solution phase. For example, step (d-1) may comprise removing the portion of the heated aqueous solution phase from the second mixture to provide a balanced mixture having a volume ratio of from about 3:1 to about 1:3 of heated extraction agent phase to heated aqueous solution phase. In some implementations, step (d-1) comprises removing the portion of the heated aqueous solution phase from the second mixture to provide a balanced mixture having a volume ratio of from about 2:1 to about 1:2 of heated extraction agent phase to heated aqueous solution phase. And, in some implementations, step (d-1) comprises removing the portion of the heated aqueous solution phase from the second mixture to provide a balanced mixture having a volume ratio of about 1:1.

In some implementations, step (d-1) comprises detecting the volume of the heated extraction agent phase or the volume of heated aqueous solution phase. Any suitable detector may be used to detect the volume of the heated extraction agent phase or the volume of heated aqueous solution phase.

In some implementations, step (e-1) comprises reducing the temperature of the balanced mixture to a temperature of from about 15° C. to about 45° C. to form the cooled mixture. For example, step (e-1) may comprise reducing the temperature of the balanced mixture to a temperature of from about 15° C. to about 35° C. to form the cooled mixture. In other implementations, step (e-1) comprises reducing the temperature of the balanced mixture to a temperature of from about 25° C. to about 45° C. to form the cooled mixture. And in some implementations, step (e-1) comprises reducing the temperature of the balanced mixture to about ambient temperature to form the cooled mixture.

In some implementations, step (e-1) comprises mixing the cooled mixture to form the cooled extraction agent phase and the cooled aqueous solution phase. For example, step (e-1) may comprise mixing the cooled mixture at ambient temperature to form the cooled extraction agent phase and the cooled aqueous solution phase. In other implementations, step (e-1) comprises mixing the cooled mixture for a period of from about 1 second to about 5 minutes (e.g., from about 3 seconds to about 5 minutes, from about 30 seconds to about 3 minutes, from about 30 seconds to about 2 minutes, from about 30 seconds to about 1.5 minutes, from about 10 seconds to about 30 seconds, from about 5 seconds to about 2 minutes, from about 5 seconds to about 1.5 minutes, or about 1 minute) to form the cooled extraction agent phase and the cooled aqueous solution phase.

In some implementations, step (f-1) comprises removing from about 50% to about 100% (e.g., from about 50% to no greater than 100%) of the cooled aqueous solution phase from the cooled mixture. For example, step (f-1) may comprise removing from about 75% to about 90% of the cooled aqueous solution phase from the cooled mixture. In other implementations, step (f-1) comprises removing from about 80% to about 100% of the cooled aqueous solution phase from the cooled mixture. In some implementations, step (f-1) comprises removing from about 70% to about 100% of the cooled aqueous solution phase from the cooled mixture. And, in some implementations, step (f-1) comprises removing about 100% of the cooled aqueous solution phase from the cooled mixture

In some implementations, step (g-1) comprises heating the concentrated extraction agent mixture to a temperature of from about 40° C. to about 110° C. (e.g., from about 45° C. to about 90° C., from about 50° C. to about 85° C., from about 60° C. to about 80° C., or from about 70° C. to about 90° C.).

The water phase has a concentration of sodium chloride that is less than the concentration of sodium chloride in the aqueous solution. The water phase may have any concentration of sodium chloride as described herein. For example, the water phase may have a concentration of sodium chloride that is from about 70% to about 99% less than the concentration of sodium chloride in the aqueous solution. The water phase may have any TDS as described herein.

In some implementations, the method optionally comprises
(h-1) treating at least a portion of the water phase to remove extraction agent.
   For example, step (h-1) comprises sparging, distilling, or osmotically filtering the water phase to remove extraction agent from the water phase.

### A. Other Implementations

In another aspect, the present invention provides a method for extracting water from an aqueous solution. The method comprises:
(a-2) mixing an extraction agent and the aqueous solution at about ambient temperature to form a first feed mixture including a wet extraction agent phase and a raffinate phase, wherein the aqueous solution comprises a concentration of sodium chloride;
(b-2) removing at least a portion of the raffinate phase from the first feed mixture;
(c-2) heating the wet extraction agent phase to a temperature of from about 40° C. to about 110° C. to form a second feed mixture including a heated extraction agent phase and a heated aqueous solution phase;
(d-2) removing a portion of the heated extraction agent phase from the second mixture to provide a balanced mixture having a volume ratio of from about 5:1 to about 1:10 of heated extraction agent phase to heated aqueous solution phase;
(e-2) reducing the temperature of the balanced mixture by at least 15° C. to form a cooled mixture and mixing the cooled mixture to form a cooled extraction agent phase and a cooled aqueous solution phase;
(f-2) removing at least a portion of the cooled aqueous solution phase from the cooled mixture to form a concentrated extraction agent mixture; and
(g-2) heating the concentrated extraction agent mixture to a temperature of from about 40° C. to about 110° C. to form a dry extraction agent phase and a water phase, wherein the water phase comprises a concentration of sodium chloride that is less than the concentration of sodium chloride in the aqueous solution.

In another aspect, the present invention provides a method for extracting water from an aqueous solution. The method comprises:
(a-3) mixing a volume ratio of from about 5:1 to about 1:5 of an extraction agent to an aqueous solution at about ambient temperature to form a first feed mixture including a wet extraction agent phase and a raffinate phase, wherein the aqueous solution comprises a concentration of sodium chloride;
(b-3) removing at least a portion of the raffinate phase from the first feed mixture;
(c-3) heating the wet extraction agent phase to a temperature of from about 45° C. to about 90° C. to form a second feed mixture including a heated extraction agent phase and a heated aqueous solution phase;
(d-3) removing a portion of the heated extraction agent phase from the second mixture to provide a balanced mixture having a volume ratio of from about 3:1 to about 1:3 of heated extraction agent phase to heated aqueous solution phase;
(e-3) reducing the temperature of the balanced mixture to about ambient temperature to form a cooled mixture including a cooled extraction agent phase and a cooled aqueous solution phase;
(f-3) removing at least a portion of the cooled aqueous solution phase from the cooled mixture to form a concentrated extraction agent mixture; and
(g-3) heating the concentrated extraction agent mixture to a temperature of from about 45° C. to about 90° C. to form a dry extraction agent phase and a water phase, wherein the water phase comprises a concentration of sodium chloride that is less than the concentration of sodium chloride in the aqueous solution.

In another aspect, the present invention provides a method for extracting water from an aqueous solution. The method comprises:
(a-4) mixing a volume ratio of from about 5:1 to about 1:5 of an extraction agent to an aqueous solution at about ambient temperature to form a first feed mixture including a wet extraction agent phase and a raffinate phase, wherein the aqueous solution comprises a concentration of sodium chloride;
(b-4) removing at least a portion of the raffinate phase from the first feed mixture;
(c-4) heating the wet extraction agent phase to a temperature of from about 45° C. to about 90° C. to form a second feed mixture including a heated extraction agent phase and a heated aqueous solution phase;
(d-4) removing a portion of the heated extraction agent phase from the second mixture to provide a balanced mixture having a volume ratio of from about 3:1 to about 1:3 of heated extraction agent phase to heated aqueous solution phase;
(e-4) reducing the temperature of the balanced mixture by at least 15° C. to form a cooled mixture including a cooled extraction agent phase and a cooled aqueous solution phase;
(f-4) removing at least a portion of the cooled aqueous solution phase from the cooled mixture to form a concentrated extraction agent mixture; and
(g-4) heating the concentrated extraction agent mixture to a temperature of from about 45° C. to about 90° C. to form a dry extraction agent phase and a water phase, wherein the water phase comprises a concentration of sodium chloride that is from about 70% to about 99% less than the concentration of sodium chloride in the aqueous solution.

In another aspect, the present invention provides a method for extracting water from an aqueous solution. The method comprises:
(a-5) mixing an extraction agent and the aqueous solution at about ambient temperature to form a first feed mixture including a wet extraction agent phase and a raffinate phase, wherein the aqueous solution comprises a concentration of TDS;
(b-5) removing at least a portion of the raffinate phase from the first feed mixture;
(c-5) heating the wet extraction agent phase to a temperature of from about 35° C. to about 130° C. to form a second feed mixture including a heated extraction agent phase and a heated aqueous solution phase;
(d-5) removing a portion of the heated extraction agent phase from the second mixture to provide a balanced mixture having a volume ratio of from about 5:1 to about 1:10 of heated extraction agent phase to heated aqueous solution phase;
(e-5) reducing the temperature of the balanced mixture by at least 15° C. to form a cooled mixture including a cooled extraction agent phase and a cooled aqueous solution phase;
(f-5) removing at least a portion of the cooled aqueous solution phase from the cooled mixture to form a concentrated extraction agent mixture; and
(g-5) heating the concentrated extraction agent mixture to a temperature of from about 35° C. to about 130° C. to form a dry extraction agent phase and a water phase, wherein the water phase comprises a concentration of TDS that is less than the concentration of TDS in the aqueous solution.

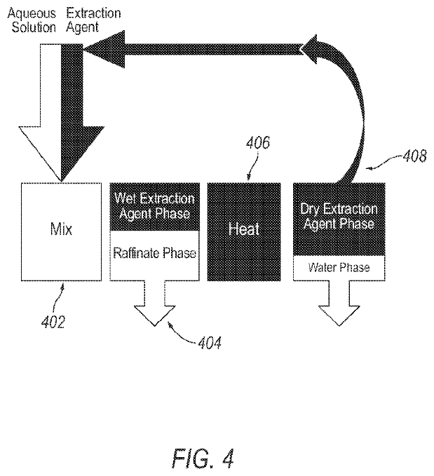

With reference to FIG. 4, a flow chart depicting another exemplary implementation of a method of extracting water from an aqueous solution is provided. The method comprises:
(a-6) mixing an extraction agent and the aqueous solution at about ambient temperature to form a first feed mixture including a wet extraction agent phase and a raffinate phase (402), wherein the aqueous solution comprises a concentration of sodium chloride;
(b-6) removing from about 50% to about 100% by volume of the raffinate phase from the first feed mixture to form a concentrated wet extraction agent phase (404);
(c-6) heating the wet extraction agent phase to a temperature of from about 35° C. to about 130° C. to form a heated mixture including a dry extraction agent phase and a water phase, wherein the water phase comprises a concentration of sodium chloride that is less than the concentration of sodium chloride in the aqueous solution (406); and
(d-6) recycling at least a portion of the dry extraction agent phase for use as extraction agent in mixing step (a-6) (408).

In some implementations, step (a-6) comprises mixing the extraction agent and the aqueous solution at a volume ratio of from about 5:1 to about 1:5. In other implementations, step (a-6) comprises mixing the extraction agent and the aqueous solution at a volume ratio of from about 3:1 to about 1:3. In some implementations, step (a-6) comprises mixing the extraction agent and the aqueous solution at a volume ratio of from about 2:1 to about 1:2. For example, step (a-6) comprises mixing the extraction agent and the aqueous solution at a volume ratio of from about 1.5:1 to about 1:1.5. And, in some implementations, step (a-6) comprises mixing the extraction agent and the aqueous solution at a volume ratio of about 1:1.

The aqueous solution may be any aqueous solution as described herein. The aqueous solution may have any concentration of sodium chloride as described herein. The aqueous solution may have any concentration of TDS as described herein.

In some implementations, step (a-6) comprises contacting at least one stream of aqueous solution with at least one stream of extraction agent. For example, step (a-6) may comprise mixing the extraction agent and the aqueous solution with a rotor or shaker. In some implementations, step (a-6) comprises mixing the extraction agent and the aqueous solution for a period of from about 1 second to about 5 minutes (e.g., from about 3 seconds to about 5 minutes, from about 30 seconds to about 3 minutes, from about 30 seconds to about 2 minutes, from about 30 seconds to about 1.5 minutes, from about 10 seconds to about 30 seconds, from about 5 seconds to about 2 minutes, from about 5 seconds to about 1.5 minutes, or about 1 minute).

In some implementations, the extraction agent has a density and the aqueous solution has a density, and the density of the extraction agent is less than the density of the aqueous solution. In other implementations, the extraction agent has a density and the aqueous solution has a density, and the density of the extraction agent is greater than the density of the aqueous solution.

The extraction agent may comprise any extraction agent as described herein. In some implementations, the extraction agent comprises a co-solvent as described herein.

In some implementations, step (b-6) comprises removing from about 80% to about 100% by volume of the raffinate phase. For example, step (b-6) may comprise removing from about 85% to about 100% by volume of the raffinate phase. In other implementations, step (b-6) comprises removing from about 80% to about 95% by volume of the raffinate phase. In other implementations, step (b-6) comprises removing from about 90% to about 100% by volume of the raffinate phase. And, in some implementations, step (b-6) comprises removing about 100% by volume of the raffinate phase.

In some implementations, step (b-6) comprises:
(b-6a) treating at least a portion of the raffinate phase to remove extraction agent and releasing the treated raffinate into the environment.
   For example, step (b-6a) comprises treating the portion of the raffinate phase by sparging or filtering with an osmotic filter. In this manner, the method ensures that the raffinate phase is free, or substantially free, of the extraction agent prior to releasing the raffinate phase into the environment.

In some implementations, the removal of the raffinate phase in step (b-6) is performed by a pump or gravity fed outlet.

In some implementations, step (c-6) comprises heating the wet extraction agent phase to a temperature of from about 40° C. to about 110° C. In some implementations, step (c-6) comprises heating the wet extraction agent phase to a temperature of from about 45° C. to about 90° C. In other implementations, step (c-6) comprises heating the wet extraction agent phase to a temperature of from about 50° C. to about 85° C. And, in some implementations, step (c-6) comprises heating the wet extraction agent phase to a temperature of from about 60° C. to about 80° C.

In some implementations, step (c-6) comprises maintaining the temperature of the heated wet extraction agent phase for a period of from about 30 s to about 5 min. For example, step (c-6) comprises maintaining the temperature of the heated wet extraction agent phase at a temperature of from about 45° C. to about 90° C. for a period of from about 30 s to about 5 min. In other implementations, step (c-6) comprises maintaining the temperature of the heated wet extraction agent phase for a period of from about 30 s to about 10 min. In some implementations, step (c-6) comprises maintaining the temperature of the heated wet extraction agent phase for a period of from about 2.5 min to about 7.5 min. And, in some implementations, step (c-6) comprises maintaining the temperature of the heated wet extraction agent phase for a period of about 5 min.

In some implementations, the heating of step (c-6) is performed by one or more solar-powered heating elements. In this manner, the method further reduces costs associated with the heating process.

The water phase has a concentration of sodium chloride that is less than the concentration of sodium chloride in the aqueous solution. The water phase may have any concentration of sodium chloride as described herein. For example, the water phase may have a concentration of sodium chloride that is from about 70% to about 99% less than the concentration of sodium chloride in the aqueous solution.

In some implementations, the water phase has a concentration of TDS. The water phase may have any concentration of TDS as described herein.

In some implementations, step (c-6) comprises:
(c-6a) treating at least a portion of the water phase to remove extraction agent.
   For example, step (c-6a) comprises treating the portion of the water phase by sparging or filtering with an osmotic filter. In this manner, the method ensures that the water phase is free, or substantially free, of the extraction agent.

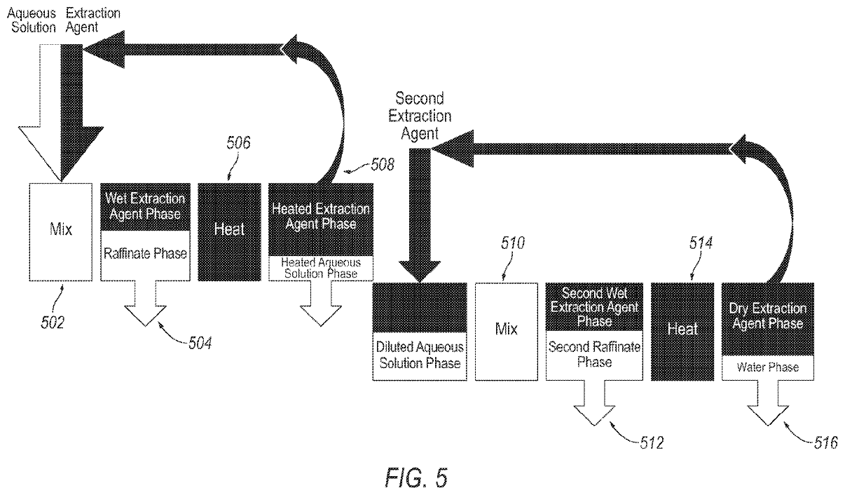

With reference to FIG. 5, a flow chart depicting another exemplary implementation of a method of extracting water from an aqueous solution is provided. The method comprises:
(a-7) mixing a first extraction agent and the aqueous solution at about ambient temperature to form a first feed mixture including a wet extraction agent phase and a raffinate phase (502), wherein the aqueous solution comprises a concentration of sodium chloride;
(b-7) removing at least a portion of the raffinate phase from the first feed mixture (504);
(c-7) heating the wet extraction agent phase to a temperature of from about 35° C. to about 130° C. to form a second feed mixture including a heated extraction agent phase and a heated aqueous solution phase (506);
(d-7) removing at least a portion of the heated extraction agent phase from the second feed mixture to provide a diluted aqueous solution phase (508);
(e-7) mixing the diluted aqueous solution phase with a second extraction agent to form a second wet extraction agent phase and a second raffinate phase (510);
(f-7) removing at least a portion of the second raffinate phase to form a concentrated wet extraction agent phase (512);
(g-7) heating the concentrated wet extraction agent phase to a temperature of from about 35° C. to about 130° C. to form a dry extraction agent phase and a water phase (514); and
(h-7) recovering the water phase (516),
   wherein the water phase has a concentration of sodium chloride that is less than the concentration of sodium chloride in the aqueous solution.

In some implementations, step (a-7) comprises mixing the first extraction agent and the aqueous solution at a volume ratio of from about 5:1 to about 1:5. In other implementations, step (a-7) comprises mixing the first extraction agent and the aqueous solution at a volume ratio of from about 3:1 to about 1:3. In some implementations, step (a-7) comprises mixing the first extraction agent and the aqueous solution at a volume ratio of from about 2:1 to about 1:2. For example, step (a-7) comprises mixing the first extraction agent and the aqueous solution at a volume ratio of from about 1.5:1 to about 1:1.5. And, in some implementations, step (a-7) comprises mixing the first extraction agent and the aqueous solution at a volume ratio of about 1:1.

In some implementations, step (a-7) comprises mixing the first extraction agent and the aqueous solution for a period of from about 3 seconds to about 5 minutes. In other implementations, step (a-7) comprises mixing the first extraction agent and the aqueous solution for a period of from about 30 seconds to about 3 minutes. In some implementations, step (a-7) comprises mixing the first extraction agent and the aqueous solution for a period of from about 30 seconds to about 2 minutes. In some implementations, step (a-7) comprises mixing the first extraction agent and the aqueous solution for a period of from about 30 seconds to about 1.5 minutes. In some implementations, step (a-7) comprises mixing the first extraction agent and the aqueous solution for a period of from about 5 seconds to about 2 minutes. In some implementations, step (a-7) comprises mixing the first extraction agent and the aqueous solution for a period of from about 5 seconds to about 1.5 minutes. And, in some implementations, step (a-7) comprises mixing the first extraction agent and the aqueous solution for a period of about 1 minute.

In some implementations, the first extraction agent has a density and the aqueous solution has a density, and the density of the first extraction agent is less than the density of the aqueous solution. In other implementations, the first extraction agent has a density and the aqueous solution has a density, and the density of the first extraction agent is greater than the density of the aqueous solution.

The first extraction agent may comprise any extraction agent as described herein. In some implementations, the first extraction agent comprises a co-solvent as described herein.

The aqueous solution may be any aqueous solution as described herein. The aqueous solution may have any concentration of sodium chloride as described herein. For example, the aqueous solution may comprise a concentration of sodium chloride of from about 350 mg/L to about 40,000 mg/L. In some implementations, the aqueous solution comprises a concentration of TDS. The aqueous solution may have any concentration of TDS as described herein.

In some implementations, the aqueous solution has a concentration of sodium chloride of greater than about 8,500 mg/L. For example, the aqueous solution may have a concentration of sodium chloride of 10,000 mg/L to about 50,000 mg/L. In some implementations, the aqueous solution has a concentration of sodium chloride of 15,000 mg/L to about 45,000 mg/L. In some implementations, the aqueous solution has a concentration of sodium chloride of 20,000 mg/L to about 40,000 mg/L. In some implementations, the aqueous solution has a concentration of sodium chloride of from about 27,000 mg/L to about 37,000 mg/L.

In some implementations, step (b-7) comprises removing from about 50% to about 100% by volume of the raffinate phase from the first feed mixture. For example, step (b-2) may comprise removing from about 80% to about 100% by volume of the raffinate phase from the first feed mixture. In other implementations, step (b-7) comprises removing from about 70% to about 100% by volume of the raffinate phase from the first feed mixture. And, in some implementations, step (b-7) comprises removing about 100% by volume of the raffinate phase from the first feed mixture.

In some implementations, step (c-7) comprises heating the wet extraction agent phase to a temperature of from about 40° C. to about 110° C. (e.g., from about 45° C. to about 90° C., from about 50° C. to about 85° C., from about 60° C. to about 80° C., or from about 70° C. to about 90° C.).

In some implementations, step (d-7) comprises
(d-7a) recycling at least a portion of the heated extraction agent removed from the second feed mixture for use as extraction agent in mixing step (a-7). In this manner, the method further reduces costs associated with the extraction process.

In some implementations, step (e-7) comprises reducing the temperature of the diluted aqueous solution phase by from about 10° C. to about 60° C. prior to mixing with the second extraction agent. In some implementations, step (e-7) comprises reducing the temperature of the diluted aqueous solution phase by from about 15° C. to about 45° C. prior to mixing with the second extraction agent. For example, step (e-7) may comprise reducing the temperature of the diluted aqueous solution phase by from about 15° C. to about 35° C. prior to mixing with the second extraction agent. In some implementations, step (e-7) comprises reducing the temperature of the diluted aqueous solution phase by from about 25° C. to about 45° C. prior to mixing with the second extraction agent. And, in some implementations, step (e-7) comprises reducing the temperature of the diluted aqueous solution phase to about ambient temperature prior to mixing with the second extraction agent.

The second extraction agent may comprise any extraction agent as described herein. In some implementations, the second extraction agent comprises a co-solvent as described herein. In some implementations, the second extraction agent and the first extraction agent are the same. In other implementations, the second extraction agent and the first extraction agent are different.

In some implementations, step (f-7) comprises removing from about 50% to about 100% by volume of the second raffinate phase. For example, step (f-7) may comprise removing from about 75% to about 90% by volume of the second raffinate phase. In other implementations, step (f-7) comprises removing from about 80% to about 100% by volume of the second raffinate phase from the first feed mixture. In some implementations, step (f-7) comprises removing from about 70% to about 100% by volume of the second raffinate phase. And, in some implementations, step (f-7) comprises removing about 100% by volume of the second raffinate phase.

In some implementations, step (g-7) comprises heating the concentrated wet extraction agent phase to a temperature of from about 40° C. to about 110° C. (e.g., from about 45° C. to about 90° C., from about 50° C. to about 85° C., from about 60° C. to about 80° C., or from about 70° C. to about 90° C.).

The water phase has a concentration of sodium chloride that is less than the concentration of sodium chloride in the aqueous solution. The water phase may have any concentration of sodium chloride as described herein. For example, the water phase may have a concentration of sodium chloride that is from about 70% to about 90% less than the concentration of sodium chloride in the aqueous solution.

In some implementations, the water phase has a concentration of TDS. The water phase may have any concentration of TDS as described herein.

In some implementations, the method further comprises:
(i-7) recycling at least a portion of the dry extraction agent phase for use as extraction agent in mixing step (a-7). In this manner, the method further reduces costs associated with the extraction process.

In some implementations, the method further comprises:
(j-7) treating at least a portion of the water phase to remove extraction agent.

For example, step (j-7) comprises sparging or osmotically filtering the water phase to remove extraction agent from the water phase. In this manner, the method ensures that the water phase is free, or substantially free, of the extraction agent.

In one aspect, the present invention provides a method of extracting water from an aqueous solution. The method comprises:
(a-8) mixing an extraction agent and the aqueous solution at about ambient temperature to form a first feed mixture including a wet extraction agent phase and a raffinate phase, wherein the aqueous solution comprises a concentration of sodium chloride;
(b-8) removing from about 80% to about 100% by volume of the raffinate phase from the first feed mixture to form a concentrated wet extraction agent phase;
(c-8) heating the wet extraction agent phase to a temperature of from about 45° C. to about 90° C. to form a heated mixture including a dry extraction agent phase and a water phase, wherein the water phase comprises a concentration of sodium chloride that is from about 70% to about 99% less than the concentration of sodium chloride in the aqueous solution; and
(d-8) recycling at least a portion of the dry extraction agent phase for use as extraction agent in mixing step (a-8).

In another aspect, the present invention provides a method of extracting water from an aqueous solution. The method comprises:
(a-9) mixing an extraction agent and the aqueous solution at a volume ratio of from about 5:1 to about 1:5 at about ambient temperature to form a first feed mixture including a wet extraction agent phase and a raffinate phase, wherein the aqueous solution comprises a concentration of sodium chloride;
(b-9) removing from about 50% to about 100% by volume of the raffinate phase from the first feed mixture to form a concentrated wet extraction agent phase;
(c-9) heating the wet extraction agent phase to a temperature of from about 45° C. to about 90° C. to form a heated mixture including a dry extraction agent phase and a water phase, wherein the water phase comprises a concentration of sodium chloride that is from about 70% to about 99% less than the concentration of sodium chloride in the aqueous solution; and
(d-9) recycling at least a portion of the dry extraction agent phase for use as extraction agent in mixing step (a-9).

In one aspect, the present invention provides a method for extracting water from an aqueous solution. The method comprises:
(a-10) mixing a first extraction agent and the aqueous solution at about ambient temperature to form a first feed mixture including a wet extraction agent phase and a raffinate phase, wherein the aqueous solution comprises a concentration of sodium chloride;
(b-10) removing from about 50% to about 100% of the raffinate phase from the first feed mixture;
(c-10) heating the wet extraction agent phase to a temperature of from about 45° C. to about 90° C. to form a second feed mixture including a heated extraction agent phase and a heated aqueous solution phase;
(d-10) removing at least a portion of the heated extraction agent phase from the second feed mixture to provide a diluted aqueous solution phase;
(e-10) reducing the temperature of the diluted aqueous solution phase to about ambient temperature, and mixing the diluted aqueous solution phase with a second extraction agent to form a second wet extraction agent phase and a second raffinate phase;
(f-10) removing from about 50% to about 100% of the second raffinate phase to form a concentrated wet extraction agent phase;
(g-10) heating the concentrated wet extraction agent phase to a temperature of from about 45° C. to about 90° C. to form a dry extraction agent phase and a water phase; and
(h-10) recovering the water phase,
   wherein the water phase has a concentration of sodium chloride that is less than the concentration of sodium chloride in the aqueous solution.

In one aspect, the present invention provides a method for extracting water from an aqueous solution. The method comprises:
(a-11) mixing a first extraction agent and the aqueous solution at about ambient temperature to form a first feed mixture including a wet extraction agent phase and a raffinate phase, wherein the aqueous solution comprises a concentration of TDS;
(b-11) removing at least a portion of the raffinate phase from the first feed mixture;
(c-11) heating the wet extraction agent phase to a temperature of from about 35° C. to about 130° C. to form a second feed mixture including a heated extraction agent phase and a heated aqueous solution phase;
(d-11) removing at least a portion of the heated extraction agent phase from the second feed mixture to provide a diluted aqueous solution phase;
(e-11) mixing the diluted aqueous solution phase with a second extraction agent to form a second wet extraction agent phase and a second raffinate phase;
(f-11) removing at least a portion of the second raffinate phase to form a concentrated wet extraction agent phase;
(g-11) heating the concentrated wet extraction agent phase to a temperature of from about 35° C. to about 130° C. to form a dry extraction agent phase and a water phase; and
(h-11) recovering the water phase,
   wherein the water phase has a concentration of TDS that is less than the concentration of TDS in the aqueous solution.

In one aspect, the present invention provides a method for extracting water from an aqueous solution. The method comprises:
(a-12) mixing an extraction agent and the aqueous solution at about ambient temperature to form a first feed mixture including a wet extraction agent phase and a raffinate phase, wherein the aqueous solution comprises a concentration of TDS;
(b-12) removing from about 50% to about 100% by volume of the raffinate phase from the first feed mixture to form a concentrated wet extraction agent phase;
(c-12) heating the wet extraction agent phase to a temperature of from about 35° C. to about 130° C. to form a heated mixture including a dry extraction agent phase and a water phase, wherein the water phase comprises a concentration of TDS that is less than the concentration of TDS in the aqueous solution; and
(d-12) recycling at least a portion of the dry extraction agent phase for use as extraction agent in mixing step (a-12).

Any embodiment of any balancer described herein may be suitable for any implementation of any method described herein. Additionally, any embodiment of any system described herein may be suitable for any implementation of any method described herein.

Without wishing to be bound by theory, it is believed that the methods described herein require less electricity than conventional methods for extracting water from aqueous solutions. For example, the heating and/or mixing cycles associated with the methods described herein are relatively mild and require less electricity than conventional systems. Additionally, recycling the extraction agent further reduces the costs associated with the extraction process. Moreover, in applicable implementations, the formation of the balanced mixture, cooling, and subsequent heating is believed to improve the efficiency of the methods. Accordingly, the methods described herein provide efficient, and cost effective, access to water from aqueous solutions.

### V. Examples

### Example 1: Extraction of Water from a 0.6M NaCl Solution

General Method: The following method is an exemplary method of Example 1.

The extraction agent (100 mL) and the aqueous solution (100 mL) were mixed in a 500 mL separatory funnel at ambient temperature for about one (1) minute. A wet extraction agent phase (less dense; top layer) and a raffinate phase (more dense; bottom layer) were allowed to form and separate. The raffinate phase was removed and the wet extraction agent phase was transferred to a graduated cylinder. The wet extraction agent phase was heated at about 85° C. for about 5 minutes. The heated wet extraction agent phase reached a temperature of from about 65° C. to about 75° C. and formed a heated extraction agent phase (less dense; top layer) and a heated aqueous solution phase (more dense; bottom layer). A portion of the heated extraction agent phase was removed to provide a balanced mixture having a volume ratio of 1:1 of heated extraction agent phase to heated aqueous solution phase. The balanced mixture was allowed to cool to about 21° C. and the balanced mixture was transferred to a separatory funnel. The balanced mixture was mixed for one (1) minute. A cooled extraction agent phase (less dense; top layer) and a cooled aqueous solution phase (more dense, bottom layer) were allowed to form and separate. The cooled aqueous solution phase was removed and the cooled extraction agent phase was transferred to a graduated cylinder. The cooled extraction agent phase was heated at about 85° C. for 5 minutes. The cooled extraction agent phase reached a temperature of from about 65° C. to about 75° C. and formed a dry extraction agent phase (less dense; top layer) and a water phase (more dense; bottom layer). The water phase was recovered and its salt concentration was analyzed via gravimetric analysis.

In some General Method Runs, one or both of the extraction agent and the aqueous solution were dyed, as indicated in Table 1. Other General Method Runs were modified as indicated in the tables below.

Aqueous solutions: 0.6M NaCl solutions were prepared by placing 35 g of NaCl in a 1 L Class B volumetric flask. Deionized water (700 mL) was added to the volumetric flask and the volumetric flask was swirled and inverted at least three times. Additional deionized water was added as necessary to reach the graduated mark of the volumetric flask. The mass of the resultant NaCl solution was determined by gravimetric analysis.

Extraction Agents: Dipropylamine, was used as the extraction agent. In the tables below, dipropylamine is referred to as “DPA”.

Gravimetric Analysis: For gravimetric analysis, the recovered water phase was dried in an oven at 66° C. until the water was removed and only salt remained. The mass of the remaining salt was determined and used to calculate the salt concentration of the water phase.

Dyes for Aqueous Solution and Extraction Agent: For the aqueous solutions, methylene blue (CAS: 61-73-4) was used as a dye. For the extraction agent, isopropyl alcohol (CAS 67-63-0) saturated with Sudan III (CAS: 85-86-9) was used as a dye. The methods used in extraction runs 1-12 are set forth in Table 1A below.

TABLE 1A
Methods used in extraction runs 1-12.

| | Volume | | Aqueous | Water | |
|---|---|---|---|---|---|
| | Ratio of | Extrac- | Solution | Bath | |
| Run | Balanced | tion | NaCl | Temp | |
| # | Mixture¹ | Agent | Molarity (M) | (° C.) | Description |
| 1 | 1:1 | DPA | 0.601813826 | 90 | Dyed extraction |
| | | | | | agent |
| 2 | 1:1 | DPA | 0.602498289 | 85 | Dyed extraction |
| | | | | | agent and |
| | | | | | aqueous solution |
| 3 | 1:1 | DPA | 0.602156058 | 85 | Dyed extraction |
| | | | | | agent |
| 4 | 1:1 | DPA | 0.610198494 | 85 | Dyed extraction |
| | | | | | agent |
| 5 | 1:1 | DPA | 0.601471595 | 85 | No dyes |
| 6 | 1:1 | DPA | 0.602984942 | 85 | Wet extraction |
| | | | | | agent phase |
| | | | | | heated for 8 |
| | | | | | minutes instead of |
| | | | | | 5 minutes |
| 7 | 1:1 | DPA | 0.603524983 | 90 | Recycled |
| | | | | | extraction agent |
| | | | | | used (i.e., |
| | | | | | extraction agent |
| | | | | | used in a previous |
| | | | | | run and recovered |
| | | | | | in the heated |
| | | | | | extraction agent |
| | | | | | phase and/or dry |
| | | | | | extraction agent |
| | | | | | phase) |
| 8 | 1:1 | DPA | 0.608316222 | 95 | Balanced mixture |
| | | | | | formed while |
| | | | | | actively heating |
| | | | | | (i.e., portion of |
| | | | | | the heated |
| | | | | | extraction agent |
| | | | | | removed while in |
| | | | | | water bath) |
| 9 | 1:1 | DPA | 0.600901209 | 95 | — |
| 10 | 2:1 | DPA | 0.616016427 | 95 | — |
| 11 | 1:2 | DPA | 0.60523614 | 95 | — |
| 12 | 1:1 | DPA | ~0.605065024 | 95 | 500 mL of |
| | | | | | aqueous solution |
| | | | | | mixed with 500 |
| | | | | | mL of extraction |
| | | | | | agent |
| | | | | | Wet extraction |
| | | | | | agent phase |
| | | | | | heated for 8 |
| | | | | | minutes instead of |
| | | | | | 5 minutes |

¹(heated extraction agent phase:heated aqueous solution phase)

The results of extraction runs 1-12 are set forth in Table 1B below.

TABLE 1B
Results of extraction runs 1-12.

| | | | | Water |
|---|---|---|---|---|
| | Water | Water | Water | Phase |
| | Phase | Phase | Phase | NaCl |
| Run | Molarity | NaCl Conc. | Volume | Recovered |
| # | (M) | (mg/kg) | (mL) | (g) |
| 1 | 5.9518495E−03 | 347.83 | 1.1500 | 0.0004 |
| 2 | 0.012833676 | 750.00 | 0.8000 | 0.0006 |
| 3 | 0.045630846 | 2666.67 | 0.9000 | 0.0024 |
| 4 | 0.044001173 | 2571.43 | 0.7000 | 0.0020 |
| 5 | 0.021778359 | 1272.73 | 1.1000 | 0.0014 |
| 6 | 0.01818104 | 1062.50 | 1.6000 | 0.0017 |
| 7 | 0.017111567 | 1000.00 | 1.2000 | 0.0012 |
| 8 | 0.015400411 | 900.00 | 1.0000 | 0.0009 |
| (1^{st} weigh) | | | | |
| 8 | 0.011978097 | 700.00 | 1.0000 | 0.0007 |
| (2^{nd} Weigh) | | | | |
| 8 | 0.01026694 | 600.00 | 1.0000 | 0.0006 |
| (3^{rd} Weigh) | | | | |
| 9 | 0.005703855807 | 333.33 | 1.2000 | 0.0004 |
| (1^{st} Weigh) | | | | |
| 9 | 0.011407712 | 666.67 | 1.2000 | 0.0008 |
| (2^{nd} Weigh) | | | | |
| 9 | 0.012833676 | 750.00 | 1.2000 | 0.0009 |
| (3^{rd} Weigh) | | | | |
| 10 | 0.011978097 | 700.00 | 2.0000 | 0.0014 |
| 11 | 0.01425964 | 833.33 | 0.6000 | 0.0005 |
| 12 | 0.010790122 | 1046.15 | 6.5000 | 0.0068 |
| (1^{st} & 2^{nd} | | | | |
| Weigh) | | | | |
| 12 | 0.017374822 | 1015.38 | 6.5000 | 0.0066 |
| (3^{rd} Weigh) | | | | |
| 12 | 0.016321803 | 953.85 | 6.5000 | 0.0062 |
| (4^{th}, 5^{th}, & 6^{th} | | | | |
| Weigh) | | | | |
| 12 | 0.016848313 | 984.62 | 6.5000 | 0.0064 |
| (Final Weigh) | | | | |

Conductivity Reading Compensated for Trace Extraction Agent (Run 12): Another technique used to measure the water phase was conductivity. For accuracy, conductivity analysis was only performed on the water phase of Run 12 due to the larger volume of water phase recovered. It was believed that the presence of extraction agent in the water phase would impact the conductivity measurement of the water phase.

To compensate for the impact of the extraction agent on the conductivity of the water phase, a 3000 mg/kg NaCl solution (Solution 1) and a 3000 mg/kg NaCl solution with trace extraction agent (Solution 2) were prepared. The conductivities of Solution 1 and Solution 2 were determined in μS/cm. The following conversion factor was used: μS/cm*0.64=mg/L. Thus, a 3000 mg/kg NaCl solution has a theoretical conductivity of 4687.5 μS/cm.

Solution 1 was prepared in a 50 mL volumetric flask by dissolving approximately 0.15 g of NaCl in 50 mL of deionized water. A conductivity probe was placed in Solution 1 (3000 mg/kg solution) and a conductivity of 4084.9654 μS/cm was measured.

Solution 2 was prepared similarly to Solution 1 but with trace amounts of the extraction agent. Approximately 100 mL of deionized water was added to a separatory funnel and DPA was added to the funnel dropwise and shaken until two phases formed. Upon the formation of two phases, the aqueous phase was extracted. The solution was prepared in a 50 mL volumetric flask by dissolving 0.15 g NaCl in 50 mL of the extracted aqueous phase. The same conductivity probe was placed in Solution 2 and a conductivity of 8820.5951 μS/cm was measured.

Therefore, the difference in conductivity between Solution 1 and Solution 2 was ˜4000 μS/cm. This change in conductivity of ˜4000 μS/cm was used along with the conductivity of the water phase measured in Run 12 in order to calculate the compensated conductivity of the water phase in Run 12 and its respective NaCl concentration in mg/kg.

In Run 12, the conductivity of the water phase was measured as 4296.62 μS/cm. Based on the difference in conductivity between Solutions 1 and 2 (i.e., ˜4000 μS/cm) the compensated conductivity for Run 12 was: 4296.62 μS/cm-4000 μS/cm=296.62 μS/cm. This compensated conductivity for Run 12 results in a calculated NaCl concentration of the water phase in Run 12 of 189.84 mg/kg

### Example 2: Extraction of Water from Simulated Seawater, Brackish Water, and Well Water

Two methods of extracting water from different aqueous solutions with different extraction agents were examined.

Method A: The extraction agent (100 mL) and the aqueous solution (100 mL) were mixed in a separatory funnel at ambient temperature for one (1) minute. A wet extraction agent phase (less dense; top layer) and a raffinate phase (more dense; bottom layer) were allowed to form and separate. The raffinate phase was removed and the wet extraction agent phase was transferred to a pear shaped flask. The wet extraction agent phase was heated to 80° C. for 5 minutes and the heated wet extraction agent phase formed a dry extraction agent phase (less dense; top layer) and a water phase (more dense; bottom layer). The water phase was recovered and its salt concentration was analyzed via atomic emission spectroscopy and/or gravimetric analysis. The dry extraction agent phase was suitable for reuse as extraction agent in subsequent runs.

Method B: The extraction agent (100 mL) and the aqueous solution (100 mL) were mixed in a separatory funnel at ambient temperature for one (1) minute. A wet extraction agent phase (less dense; top layer) and a raffinate phase (more dense; bottom layer) were allowed to form and separate. The raffinate phase was removed and the wet extraction agent phase was transferred to a graduated cylinder. The wet extraction agent phase was heated to 80° C. for 5 minutes and formed a heated extraction agent phase (less dense; top layer) and a heated aqueous solution phase (more dense; bottom layer). The heated extraction agent phase was removed while warm to provide a balanced mixture having a volume ratio of 1:1 of heated extraction agent phase to heated aqueous solution phase. The balanced mixture was cooled to ambient temperature and mixed for 1 minute. A cooled extraction agent phase (less dense; top layer) and a cooled aqueous solution phase (more dense; bottom layer) were allowed to form and separate. The cooled aqueous solution phase was removed. The cooled extraction phase was heated to 80° C. for 5 minutes and formed a dry extraction agent phase (less dense; top layer) and a water phase (more dense; bottom layer). The water phase was recovered and its salt concentration was analyzed via atomic emission spectroscopy and/or gravimetric analysis. The dry extraction agent phase and the recovered heated extraction agent phase were suitable for reuse as extraction agent in subsequent runs.

Simulated Aqueous Solutions: A seawater simulant was prepared having a concentration of sodium chloride of 35,064 mg/L. A brackish water simulant was prepared having a concentration of sodium of chloride of 4,090 mg/L. Additionally, various well water simulants having different salt concentrations were prepared based on various well water compositions in Egypt. The various well water simulants, along with their major ion concentrations and total dissolved solids (TDS), are set forth in Table 2A below.

TABLE 2A
Well water simulant formulations.

| | Well | Well | Well | Well | Well | Well | Well | Well |
|---|---|---|---|---|---|---|---|---|
| | Water | Water | Water | Water | Water | Water | Water | Water |
| | # 1 | # 2 | # 3 | # 4 | # 5 | # 6 | # 7 | # 8 |
| Ca⁺ | 43.9 | 26.3 | 65.2 | 29.8 | 498.1 | 93.2 | 583.3 | 79.7 |
| (mg/L) | | | | | | | | |
| Mg²⁺ | 162.9 | 65.1 | 160.5 | 110.5 | 229.7 | 26.6 | 212.8 | 31.8 |
| (mg/L) | | | | | | | | |
| Na⁺ | 446.9 | 34.7 | 275.1 | 142.7 | 1191.5 | 335.4 | 1200.0 | 1020.0 |
| (mg/L) | | | | | | | | |
| K⁺ | 22.4 | 5.5 | 10.2 | 10.0 | 19.0 | 8.2 | 12.0 | 9.0 |
| (mg/L) | | | | | | | | |
| CO₃²⁻ | 6 | 22 | 6 | 12 | 3.8 | 11.2 | 6.0 | 9.0 |
| (mg/L) | | | | | | | | |
| HCO₃⁻ | 390.4 | 412.2 | 329.4 | 396.0 | 281.6 | 171.5 | 97.6 | 1340.2 |
| (mg/L) | | | | | | | | |
| SO₄²⁻ | 404.4 | 10.6 | 196.7 | 114.6 | 1307.6 | 439.1 | 1900.0 | 1085.0 |
| (mg/L) | | | | | | | | |
| Cl⁻ | 762.2 | 29.2 | 644.8 | 271.0 | 2359.4 | 355.9 | 2185.30 | 938.4 |
| (mg/L) | | | | | | | | |
| TDS | 2043.9 | 399.5 | 1523.2 | 888.7 | 5712 | 1381.2 | 6157 | 3258 |
| (mg/L) | | | | | | | | |

| | Well | Well | Well |
|---|---|---|---|
| | Water | Water | Water |
| | # 9 | # 10 | # 11 |
| Ca⁺ | 471.0 | 465.8 | 126.7 |
| (mg/L) | | | |
| Mg²⁺ | 290.0 | 58.61 | 44.21 |
| (mg/L) | | | |
| Na⁺ | 900.0 | 800 | 720 |
| (mg/L) | | | |
| K⁺ | 23.0 | 7 | 11 |
| (mg/L) | | | |
| CO₃²⁻ | 0.0 | 12 | 9 |
| (mg/L) | | | |
| HCO₃⁻ | 30.0 | 228.75 | 125.05 |
| (mg/L) | | | |
| SO₄²⁻ | 181.0 | 1964 | 1015 |
| (mg/L) | | | |
| Cl⁻ | 2900.0 | 719.86 | 668.44 |
| (mg/L) | | | |
| TDS | 4795 | 4141 | 2657 |
| (mg/L) | | | |

Extraction Agents: Both dipropylamine and di-iso-propylamine were used as extraction agents. In Table 4 below, dipropylamine is referred to as “DPA” and di-iso-propylamine is referred to as “DIPA”.

Atomic Absorption Analysis: The atomic absorption analysis was performed on a Buck Scientific 210 VGP Atomic Absorption Spectrophotometer in Emission mode.

Gravimetric Analysis: For gravimetric analysis, the recovered water phase (or well water simulant or raffinate phase) was dried in an oven at 66° C. until the water was removed and only salt remained. The mass of the remaining salt was determined and used to calculate the salt concentration of the water phase.

The results of Example 2 (i.e., Runs 13-29) are set forth below in Table 2B.

TABLE 2B
Salt removal and TDS of recovered water phases.

| | | | Simulated | Salt | |
|---|---|---|---|---|---|
| Run | Extraction | | Aqueous | Removal | TDS |
| # | Agent | Method | Solution | (%)² | (mg/L)³ |
| 13 | DPA | A | Seawater | 86.80 | 4,630 |
| 14 | DPA | B | Seawater | 98.80 | 420 |
| 15 | DIPA | A | Seawater | 78.00 | 7,700 |
| 16 | DIPA | B | Seawater | 95.72 | 1,500 |
| 17 | DPA | A | Brackish | 90.71 | 380 |
| 18 | DIPA | A | Brackish | 81.42 | 760 |
| 19 | DPA | A | Well Water 1 | 84.34 | 457.14 |
| 20 | DPA | A | Well Water 2 | 96.12 | 35.29 |
| 21 | DPA | A | Well Water 3 | 89.11 | 294.12 |
| 22 | DPA | A | Well Water 4 | 81.61 | 320.00 |
| 23 | DPA | A | Well Water 5 | 93.20 | 475.00 |
| 24 | DPA | A | Well Water 6 | 95.17 | 77.78 |
| 25 | DPA | A | Well Water 7 | 96.00 | 320 |
| 26 | DPA | A | Well Water 8 | 97.02 | 100 |
| 27 | DPA | A | Well Water 9 | 88.72 | 600 |
| 28 | DPA | A | Well Water 10 | 98.47 | 90.0 |
| 29 | DPA | A | Well Water 11 | 99.12 | 30.0 |

²Salt removal (%) represents the percentage of salt removed from the simulated aqueous solution. For seawater and brackish water simulants, salt removal (%) was calculated via atomic absorption analysis. For well water simulants, salt removal (%) was calculated via gravimetric analysis.
³For seawater and brackish water simulants, TDS was calculated via atomic absorption analysis. For well water simulants, TDS was calculated via gravimetric analysis.

For each run, greater than 75% of salt was removed from the simulated aqueous solution. Moreover, Run 14 and Run 16 indicate that the balancing step may be particularly beneficial in increasing the amount of salt removed from the aqueous solutions. The results demonstrate that the methods may be suitable for extracting agricultural and/or potable water from aqueous solutions.

### Example 3: Simulated Seawater Rebalanced Extractions

Another method of extracting water from simulated seawater with DPA as the extraction agent was examined.

### Preparation of Simulated Seawater (Aqueous Solution):

To a 1 L volumetric flask was added 38.0 g of INSTANT OCEAN™ salt mix and about 700 mL of deionized water. The flask was inverted and swirled until all solids were dissolved. Deionized water was then added to give a final volume of 1 L. This process was repeated to generate 5 L of aqueous solution.

### Extraction Method:

A 1:1 volume ratio of aqueous solution to extraction agent (DPA) was added to a 11,000 mL carboy on a shaker. The carboy underwent mixing/shaking for 1 min. The raffinate phase (reject solution) was removed and its volume and mass measured. The mass and volume of the wet extraction agent phase were measured, and the wet extraction agent phase was poured into a 2000 mL glass bottle into which a temperature probe was added. The bottle was placed in a 95° C. water bath and heated to a temperature of 80° C. A portion of the heated wet extraction agent layer (top layer, reject amine) was removed to give a volume ratio of 2:1 of heated wet extraction agent phase to heated aqueous solution phase. The mixture was cooled to ambient temperature, transferred to 1 L separatory funnel, and then mixed by shaking for 1 min. The mixture was allowed to settle, the aqueous solution phase was removed (recovered water 1) and its volume and mass were measured. The mass and volume of the remaining extraction agent phase (recovered extraction agent) were measured, and the extraction agent phase was transferred to a 1000 mL glass beaker. The extraction agent was heated in a 95° C. water bath until reaching a temperature of 80° C. Using a graduated pipette, the water phase (recovered water 2) was recovered from the extraction agent.

The results of the extractions performed according to this Example 3 are set forth in Tables 3A and 3B.

TABLE 3A
Results of rebalanced water extraction - Run 1.

| | | Mass (g) | Volume (mL) |
|---|---|---|---|
| Initial Extraction | Extraction Agent | 1872.8 | 2500 |
| 1:1 Volume Ratio | Feed Solution | 2539.6 | 2500 |
| | Recovered Water 1 | — | 245 |
| Rebalance | Wet Extraction | — | 490 |
| 2:1 Volume Ratio | Agent | | |
| | Reject Amine | 382.5 | 510 |
| | Recovered | 352.5 | 470 |
| | Extraction Agent | | |
| | Reject Water | 189.1 | 195 |
| | Recovered Water 2 | 41.5 | 42 |

TABLE 3B
Results of rebalanced water extraction - Run 2.

| | | Mass (g) | Volume (mL) |
|---|---|---|---|
| Initial Extraction | Extraction Agent | 1475.1 | 2000 |
| 1:1 Volume Ratio | Simulated Seawater | 1935.7 | 2000 |
| | Recovered Water 1 | — | 200 |
| Rebalance | Wet Extraction | — | 400 |
| 2:1 Volume Ratio | Agent | | |
| | Reject Amine | 334.3 | 422.5 |
| | Recovered | 235.2 | 320 |
| | Extraction Agent | | |
| | Recovered Water 1 | — | 200 |
| | Reject Water | 143.8 | 146 |
| | Recovered Water 2 | 50.9 | 51.5 |

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method for extracting water from an aqueous solution comprising:
(a-1) mixing an extraction agent and the aqueous solution at about ambient temperature to form a first feed mixture comprising a wet extraction agent phase and a raffinate phase, wherein the aqueous solution comprises a concentration of sodium chloride;
(b-1) removing at least a portion of the raffinate phase from the first feed mixture;
(c-1) heating the wet extraction agent phase to a temperature of from about 35° C. to about 130° C. to form a second feed mixture comprising a heated extraction agent phase and a heated aqueous solution phase;
(d-1) reducing the volume of the second feed mixture to provide a balanced mixture having a volume ratio of from about 5:1 to about 1:10 of heated extraction agent phase to heated aqueous solution phase;
(e-1) reducing the temperature of the balanced mixture by at least 15° C. to form a cooled mixture comprising a cooled extraction agent phase and a cooled aqueous solution phase;
(f-1) removing at least a portion of the cooled aqueous solution phase from the cooled mixture to form a concentrated extraction agent mixture; and
(g-1) heating the concentrated extraction agent mixture to a temperature of from about 35° C. to about 130° C. to form a dry extraction agent phase and a water phase, wherein the water phase comprises a concentration of sodium chloride that is less than the concentration of sodium chloride in the aqueous solution.

2. The method of claim 1, wherein step (a-1) comprises mixing a volume ratio of from about 5:1 to about 1:5 of extraction agent to aqueous solution to form the first feed mixture.

3. The method of claim 1 or claim 2, wherein step (a-1) comprises mixing the extraction agent and the aqueous solution for a period of from about 1 second to about 5 minutes.

4. The method of any one of claims 1-3, wherein step (a-1) comprises mixing the extraction agent and the aqueous solution for a period of from about 30 seconds to about 2 minutes.

5. The method of any one of claims 1-4, wherein the extraction agent has a density that is less than the density of the aqueous solution.

6. The method of any one of claims 1-5, wherein the extraction agent comprises a tertiary or secondary amine having the formula N(R¹)₃, wherein each R¹ is independently hydrogen, an optionally substituted straight or branched C₁₋₂₀ alkyl, an optionally substituted C₁₋₁₄ mono- or bicyclic cycloalkyl, or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

7. The method of any one of claims 1-5, wherein the extraction agent comprises a di-amine having the formula (R¹)₂N-L-N(R¹)₂ wherein L is a C₁₋₁₄ bivalent, straight or branched alkylene chain, and each R¹ is independently hydrogen, an optionally substituted straight or branched C₁₋₂₀ alkyl, an optionally substituted C₁₋₁₄ mono- or bicyclic cycloalkyl, or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

8. The method of any one of claims 1-5, wherein the extraction agent comprises methylamine; ethylamine; propylamine; isopropylamine; butylamine; sec-butylamine; iso-butylamine; tert-butylamine; amylamine; hexylamine; heptylamine; 1-methylhexylamine; octylamine; 1-ethylpentylamine; 2-ethylhexylamine; 2-ethylbutylamine; 2-ethyl-1-hexylamine; tert-octylamine; nonylamine; decylamine; dodecylamine; hexadecylamine; octadecylamine; dimethylamine; diethylamine; dipropylamine; di-iso-propylamine; dibutylamine; di-sec-butylamine; di-iso-butylamine; di-tert-butylamine; diisobutylamine; N,N-ethylcyclohexylamine; N-methylcyclohexylamine; N-methyl-tert-butylamine; N-methyl-iso-butylamine; N-methylpentylamine; di-allylamine; N-ethylmethylamine; N-iso-propylmethylamine; N-methylbutylamine; N-methyl-n-amylamine; N-ethyl-tert-butylamine; N-ethyl-sec-butylamine; N-ethylpropylamine; N-ethyl-iso-propylamine; N-ethyl-n-butylamine; dioctylamine; N-methyldodecylamine; propylbutylamine; N-ethylbenzylamine; 1,3-dimethylbutylamine; N,N-dimethyl-iso-propylamine; dimethylpropylamine; N,N-dimethyl-iso-butylamine; N,N-dimethyl-tert-butylamine; N,N-dimethylcyclohexylamine; N,N-dimethylethylamine; N,N-diethylmethylamine; triethylamine; di-iso-propylmethylamine; 2-(isopropylamino) ethanol; tripropylamine; trioctylamine; N,N-dimethylhexadecylamine; 1,8-diaminooctane; 1,12-diaminododecane; 1,3-dimethylamylamine; 2-aminopentane; N,N,5,5-tetramethyl-1,3-dioxan-2amine; bis[3-trimethoxysilyl)propyl]amine; octanoic acid; decanoic acid; hexanoic acid; tri-8-chlorooctylamine; trioctylamine; trioctadecylamine; or any combination thereof.

9. The method of any one of claims 1-8, wherein the aqueous solution comprises a concentration of sodium chloride of greater than about 8,500 mg/L.

10. The method of any one of claims 1-9, wherein step (b-1) comprises removing from about 50% to no more than 100% by volume of the raffinate phase from the first feed mixture.

11. The method of any one of claims 1-10, wherein step (b-1) comprises removing from about 80% to about 100% by volume of the raffinate phase from the first feed mixture.

12. The method of any one of claims 1-11, wherein the step (c-1) comprises heating the wet extraction agent phase to a temperature of from about 45° C. to about 90° C.

13. The method of any one of claims 1-12, wherein the step (c-1) comprises heating the wet extraction agent phase to a temperature of from about 50° C. to about 85° C.

14. The method of anyone of claims 1-13, wherein step (d-1) comprises removing a portion of the heated extraction agent phase from the second mixture to provide a balanced mixture having a volume ratio of from about 5:1 to about 1:10 of heated extraction agent phase to heated aqueous solution phase.

15. The method of claim 14, wherein step (d-1) comprises removing the portion of the heated extraction agent phase from the second feed mixture to provide a balanced mixture having a volume ratio of from about 3:1 to about 1:3 of heated extraction agent phase to heated aqueous solution phase.

16. The method of anyone of claims 1-13, wherein step (d-1) comprises removing a portion of the heated aqueous solution phase from the second mixture to provide a balanced mixture having a volume ratio of from about 5:1 to about 1:10 of heated extraction agent phase to heated aqueous solution phase.

17. The method of any one of claims 1-16, wherein step (d-1) comprises detecting the volume of the heated extraction agent phase or the volume of heated aqueous solution phase.

18. The method of any one of claims 1-17, wherein step (e-1) comprises reducing the temperature of the balanced mixture to a temperature of from about 15° C. to about 35° C. to form the cooled mixture.

19. The method of any one of claims 1-18, wherein step (e-1) comprises reducing the temperature of the balanced mixture to about ambient temperature to form the cooled mixture.

20. The method of any one of claims 1-19, wherein step (f-1) comprises removing from about 50% to no more than 100% of the cooled aqueous solution phase from the cooled mixture.

21. The method of any one of claims 1-20, wherein step (f-1) comprises removing from about 75% to about 90% of the cooled aqueous solution phase from the cooled mixture.

22. The method of any one of claims 1-21, wherein step (g-1) comprises heating the concentrated extraction agent mixture to a temperature of from about 45° C. to about 90° C.

23. The method of any one of claims 1-22, wherein step (g-1) comprises heating the concentrated extraction agent mixture to a temperature of from about 50° C. to about 85° C.

24. The method of any one of claims 1-23, wherein the concentration of sodium chloride in the water phase is from about 70% to about 99% less than the concentration of sodium chloride in the aqueous solution.

25. The method of any one of claims 1-24, further comprising
(h-1) treating at least a portion of the water phase to remove extraction agent.

26. The method of claim 25, wherein step (h-1) comprises sparging or osmotically filtering the water phase to remove extraction agent from the water phase.

27. A balancer for extracting water from an aqueous solution comprising:
a first feed stream comprising a first stream channel and a first stream outlet, wherein
the first stream channel is configured to mix an extraction agent and an aqueous solution under ambient temperature to form a wet extraction phase and a raffinate phase, wherein the density of the wet extraction phase is less than the density of the raffinate phase, and the aqueous solution has a concentration of sodium chloride,
the first stream outlet is configured to permit at least a portion of the raffinate phase to exit the first stream channel and form a reduced first feed stream;
a first heater that fluidly communicates with the first stream channel and thermally communicates with the reduced first feed stream, wherein
the first heater is configured to heat at least a portion of the reduced first feed stream to a temperature of from about 35° C. to about 130° C. to form a heated extraction agent phase and a heated aqueous solution phase, and
the first heater comprises a first heater outlet configured to permit a portion of the heated extraction agent phase to exit the first heater to give a heated balanced mixture comprising a volume ratio of heated extraction agent phase to heated aqueous solution phase of from about 5:1 to about 1:10;
a second feed stream comprising a second stream channel and a second stream outlet, wherein
the second stream channel fluidly communicates with the first heater and is configured to cool the heated balanced mixture to form a volume-adjusted wet extraction agent phase and a cooled aqueous solution phase, and
the second stream outlet is configured to permit at least a portion of the cooled aqueous solution phase to exit the second stream channel and form a concentrated wet extraction agent mixture; and
an extractor fluidly communicating with the second stream channel and comprising an extractor heater and a water outlet, wherein
the extractor heater is configured to heat at least a portion of the concentrated wet extraction agent mixture to a temperature of from about 35° C. to about 130° C. to form a dry extraction agent phase and a water phase, and
the water outlet is configured permit at least a portion of the water phase to exit the extractor.

28. The balancer of claim 27, wherein the first stream channel is configured to mix the extraction agent and the aqueous solution for a period of from about 3 seconds to about 5 minutes.

29. The balancer of claim 27 or claim 28, wherein the first stream channel is configured to mix the extraction agent and the aqueous solution for a period of from about 30 seconds to about 2 minutes.

30. The balancer of any one of claims 27-29, wherein the first stream channel is configured to contact a stream of extraction agent with a stream of aqueous solution.

31. The balancer of any one of claims 27-30, wherein the first stream outlet is configured to permit the portion of the raffinate phase exiting the first stream channel to be released into the environment.

32. The balancer of any one of claims 27-31, further comprising a sparging tank fluidly communicating with the first stream outlet, wherein the sparging tank is configured to sparge at least a portion of the raffinate to remove extraction agent from the raffinate.

33. The balancer of any one of claims 27-32, wherein the first stream outlet comprises a valve fluidly coupled to the first stream channel.

34. The balancer of any one of claims 27-33, wherein the first stream outlet is configured to retain from about 75% to about 99% of the wet extraction agent phase in the first stream channel while permitting the portion of the raffinate phase to exit the first stream channel.

35. The balancer of any one of claim 27-34, further comprising a first stream actuator fluidly communicating with an upstream portion of the first feed stream wherein the first stream actuator provides the extraction agent, the aqueous solution, or both to the first stream channel.

36. The balancer of any one of claims 27-35, wherein the first heater is configured to heat the portion of the reduced first feed stream to a temperature of from about 45° C. to about 90° C.

37. The balancer of any one of claims 27-36, wherein the first heater comprises one or more heating elements.

38. The balancer of any one of claims 27-37, further comprising at least one solar cell configured to power the first heater, the extractor heater, or any combination thereof.

39. The balancer of any one of claims 27-38, further comprising a recycling conduit fluidly communicating with the first heater outlet and the first feed stream, wherein the recycling conduit is configured to permit a portion of the heated extraction agent phase to exit the first heater and return to the first feed stream as extraction agent.

40. The balancer of any one of claims 27-39, wherein the first heater outlet is configured to permit the portion of heated extraction agent phase to exit the first heater substantially free of heated raffinate phase.

41. The balancer of any one of claims 27-40, wherein the portion of heated extraction agent phase exiting the first heater comprises from 0% to about 25% by volume of the heated raffinate phase.

42. The balancer of any one of claims 27-41, wherein the extractor comprises an extraction agent outlet, and the extraction agent outlet comprises a valve configured to permit from about 75% to no greater than 100% by volume of the dry extraction agent to exit the extractor.

43. The balancer of any one of claims 27-42, further comprising a second recycling conduit fluidly communicating with the extraction agent outlet, wherein the second recycling conduit is configured to return the dry extraction agent exiting the extractor to the first feed stream as extraction agent.

44. The balancer of any one of claims 27-43, wherein in the extractor heater is configured to heat the portion of the concentrated wet extraction agent to a temperature of from about 45° C. to about 90° C.

45. The balancer of any one of claims 27-44, wherein the water phase has a concentration of sodium chloride that is less than the concentration of sodium chloride in the aqueous solution.

46. The balancer of any one of claims 27-45, wherein the water phase has a concentration of sodium chloride that is from about 65% to about 90% less than the concentration of sodium chloride in the aqueous solution.

47. The balancer of any one of claims 27-46, wherein the aqueous solution comprises a concentration of sodium chloride of greater than about 8,500 mg/L.

48. The balancer of any one of claims 27-47, wherein the aqueous solution comprises seawater or well water.

49. The balancer of any one of claims 27-48, further comprising a sparger in fluid communication with the water outlet, wherein the sparger is configured to vaporize extraction agent from the water phase.

50. The balancer of any one of claims 27-49, wherein the first heater further comprises a rate meter that cooperates with the first heater outlet to modulate the flow of the heated extraction agent phase and heated raffinate phase to form the balanced mixture.

51. The balancer of any one of claims 27-50, wherein the extraction agent comprises a tertiary or secondary amine having the formula N(R¹)₃, wherein each R¹ is independently hydrogen, an optionally substituted straight or branched C₁₋₂₀ alkyl, an optionally substituted C₁₋₁₄ mono- or bicyclic cycloalkyl, or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

52. The balancer of any one of claims 27-50, wherein the extraction agent comprises a di-amine having the formula (R¹)₂N-L-N(R¹)₂ wherein L is a C₁₋₁₄ bivalent, straight or branched alkylene chain, and each R¹ is independently hydrogen, an optionally substituted straight or branched C₁₋₂₀ alkyl, an optionally substituted C₁₋₁₄ mono- or bicyclic cycloalkyl, or an optionally substituted C₆₋₁₄ mono- or bicyclic aryl, wherein the alkyl, cycloalkyl, and aryl of R¹ are each optionally and independently substituted with up to two halogen or C₁₋₆ alkyl groups.

53. The balancer of any one of claims 27-50, wherein the extraction agent comprises methylamine; ethylamine; propylamine; isopropylamine; butylamine; sec-butylamine; iso-butylamine; tert-butylamine; amylamine; hexylamine; heptylamine; 1-methylhexylamine; octylamine; 1-ethylpentylamine; 2-ethylhexylamine; 2-ethylbutylamine; 2-ethyl-1-hexylamine; tert-octylamine; nonylamine; decylamine; dodecylamine; hexadecylamine; octadecylamine; dimethylamine; diethylamine; dipropylamine; di-iso-propylamine; dibutylamine; di-sec-butylamine; di-iso-butylamine; di-tert-butylamine; diisobutylamine; N,N-ethylcyclohexylamine; N-methylcyclohexylamine; N-methyl-tert-butylamine; N-methyl-iso-butylamine; N-methylpentylamine; di-allylamine; N-ethylmethylamine; N-iso-propylmethylamine; N-methylbutylamine; N-methyl-n-amylamine; N-ethyl-tert-butylamine; N-ethyl-sec-butylamine; N-ethylpropylamine; N-ethyl-iso-propylamine; N-ethyl-n-butylamine; dioctylamine; N-methyldodecylamine; propylbutylamine; N-ethylbenzylamine; 1,3-dimethylbutylamine; N,N-dimethyl-iso-propylamine; dimethylpropylamine; N,N-dimethyl-iso-butylamine; N,N-dimethyl-tert-butylamine; N,N-dimethylcyclohexylamine; N,N-dimethylethylamine; N,N-diethylmethylamine; triethylamine; di-iso-propylmethylamine; 2-(isopropylamino) ethanol; tripropylamine; trioctylamine; N,N-dimethylhexadecylamine; 1,8-diaminooctane; 1,12-diaminododecane; 1,3-dimethylamylamine; 2-aminopentane; N,N,5,5-tetramethyl-1,3-dioxan-2amine; bis[3-trimethoxysilyl)propyl]amine; octanoic acid; decanoic acid; hexanoic acid; tri-8-chlorooctylamine; trioctylamine; trioctadecylamine; or any combination thereof.
